(19) United States
(12) Patent Application Publication
(10) Pub. No.: US 2026/0173017 A1
(43) Pub. Date: Jun. 18, 2026

(54) AI OR ML MODEL MONITORING METHOD AND APPARATUS, AND COMMUNICATION DEVICE AND STORAGE MEDIUM

(71) Applicant: BEIJING XIAOMI MOBILE SOFTWARE CO., LTD., Beijing (CN)

(72) Inventors: Xiaolong LI, Beijing (CN); Qin MU, Beijing (CN)

(73) Assignee: BEIJING XIAOMI MOBILE SOFTWARE CO., LTD., Beijing (CN)

(21) Appl. No.: 19/126,548

(22) PCT Filed: Nov. 4, 2022
(86) PCT No.: PCT/CN2022/130112

§ 371 Date: May 1, 2025

(51) Int. Cl. H04W 64/00; H04L 41/16; H04L 41/5009

(52) U.S. Cl. CPC H04W 64/00; H04L 41/16; H04L 41/5009

(57) ABSTRACT

Provided in the embodiments of the present disclosure is an artificial intelligence (AI) or machine learning (ML) model monitoring method. The method is executed by a first communication node. The method comprises: executing performance monitoring on an AI or ML model used for terminal positioning. In the method, a first communication node may execute performance monitoring on an AI or ML model used for terminal positioning. Compared with a situation where performance monitoring cannot be performed on an AI or ML model that is used for terminal positioning, a performance monitoring result of the AI or ML model can be acquired, and the performance of the AI or ML model can be adjusted in a timely manner, such that the AI or ML model is in a high-precision prediction state, thereby improving the precision of positioning.

### CROSS REFERENCE TO RELATED APPLICATION

The present application is a U.S. National Stage of International Application No. PCT/CN2022/130112, filed on Nov. 4, 2022, the contents of which are incorporated herein by reference in its entirety.

### TECHNICAL FIELD

The present disclosure relates to, but is not limited to, the wireless communication technical field, and in particular to a method and apparatus for monitoring an Artificial Intelligence (AI) or Machine Learning (ML) model, a communication device and a storage medium.

### BACKGROUND

The 5th generation mobile communication technology (5G) New Radio (NR) introduces the artificial intelligence technology. For example, AI or ML models may be applied to 5G NR. In the positioning application scenario of 5G, an AI or ML model for positioning is introduced.

### SUMMARY

Embodiments of the present disclosure disclose a method and an apparatus for monitoring an AI or ML model, a communication device, and a storage medium.

According to a first aspect of an embodiment of the present disclosure, a method for monitoring an Artificial Intelligence (AI) or Machine Learning (ML) model is provided. The method is performed by a first communication node. The method includes:
performing performance monitoring of the AI or ML model for terminal positioning.

According to a second aspect of an embodiment of the present disclosure, a method for monitoring an Artificial Intelligence (AI) or Machine Learning (ML) model is provided. The method is performed by a second communication node, and the method includes:
sending assistance information to a first communication node;
wherein the assistance information is used for performance monitoring of the AI or ML model for terminal positioning.

According to a third aspect of an embodiment of the present disclosure, an apparatus for monitoring an Artificial Intelligence (AI) or Machine Learning (ML) model is provided. The apparatus includes:
an execution module configured to perform performance monitoring of the AI or ML model for terminal positioning;
wherein the assistance information is used for performance monitoring of the AI or ML model for terminal positioning.

According to a fourth aspect of an embodiment of the present disclosure, an apparatus for monitoring an Artificial Intelligence (AI) or Machine Learning (ML) model is provided. The apparatus includes:
a sending module configured to sending assistance information to a first communication node;
wherein the assistance information is used for performance monitoring of the AI or ML model for terminal positioning.

According to a fifth aspect of an embodiment of the present disclosure, a communication device is provided. The communication device includes:
a processor; and
a memory configured to store instructions executable by the processor;
wherein the processor is configured to implement the method described in any embodiment of the present disclosure when running the executable instructions.

According to a sixth aspect of an embodiment of the present disclosure, a computer storage medium is provided. The computer storage medium stores a computer executable program, and when the executable program is executed by a processor, the method described in any embodiment of the present disclosure is implemented.

### BRIEF DESCRIPTION OF THE DRAWINGS

FIG. 1 is a schematic structural diagram of a wireless communication system according to an example embodiment.

FIG. 2A is a schematic flowchart of a method for monitoring an Artificial Intelligence (AI) or Machine Learning (ML) model according to an example embodiment.

FIG. 2B is a schematic flowchart of a method for monitoring an Artificial Intelligence (AI) or Machine Learning (ML) model according to an example embodiment.

FIG. 3 is a schematic flowchart of a method for monitoring an Artificial Intelligence (AI) or Machine Learning (ML) model according to an example embodiment.

FIG. 4 is a schematic flowchart of a method for monitoring an Artificial Intelligence (AI) or Machine Learning (ML) model according to an example embodiment.

FIG. 5 is a schematic flowchart of a method for monitoring an Artificial Intelligence (AI) or Machine Learning (ML) model according to an example embodiment.

FIG. 6 is a schematic flowchart of a method for monitoring an Artificial Intelligence (AI) or Machine Learning (ML) model according to an example embodiment.

FIG. 7 is a schematic flowchart of a method for monitoring an Artificial Intelligence (AI) or Machine Learning (ML) model according to an example embodiment.

FIG. 8 is a schematic flowchart of a method for monitoring an Artificial Intelligence (AI) or Machine Learning (ML) model according to an example embodiment.

FIG. 9 is a schematic flowchart of a method for monitoring an Artificial Intelligence (AI) or Machine Learning (ML) model according to an example embodiment.

FIG. 10 is a schematic flowchart of a method for monitoring an Artificial Intelligence (AI) or Machine Learning (ML) model according to an example embodiment.

FIG. 11 is a schematic flowchart of a method for monitoring an Artificial Intelligence (AI) or Machine Learning (ML) model according to an example embodiment.

FIG. 12 is a schematic flowchart of a method for monitoring an Artificial Intelligence (AI) or Machine Learning (ML) model according to an example embodiment.

FIG. 13 is a schematic flowchart of a method for monitoring an Artificial Intelligence (AI) or Machine Learning (ML) model according to an example embodiment.

FIG. 14 is a schematic flowchart of a method for monitoring an Artificial Intelligence (AI) or Machine Learning (ML) model according to an example embodiment.

FIG. 15 is a schematic flowchart of a method for monitoring an Artificial Intelligence (AI) or Machine Learning (ML) model according to an example embodiment.

FIG. 16 is a schematic flowchart of a method for monitoring an Artificial Intelligence (AI) or Machine Learning (ML) model according to an example embodiment.

FIG. 17 is a schematic flowchart of a method for monitoring an Artificial Intelligence (AI) or Machine Learning (ML) model according to an example embodiment.

FIG. 18 is a schematic flowchart of a method for monitoring an Artificial Intelligence (AI) or Machine Learning (ML) model according to an example embodiment.

FIG. 19 is a schematic flowchart of a method for monitoring an Artificial Intelligence (AI) or Machine Learning (ML) model according to an example embodiment.

FIG. 20 is a schematic flowchart of a method for monitoring an Artificial Intelligence (AI) or Machine Learning (ML) model according to an example embodiment.

FIG. 21 is a schematic flowchart of a method for monitoring an Artificial Intelligence (AI) or Machine Learning (ML) model according to an example embodiment.

FIG. 22 is a schematic flowchart of a method for monitoring an Artificial Intelligence (AI) or Machine Learning (ML) model according to an example embodiment.

FIG. 23 is a schematic flowchart of a method for monitoring an Artificial Intelligence (AI) or Machine Learning (ML) model according to an example embodiment.

FIG. 24 is a schematic flowchart of a method for monitoring an Artificial Intelligence (AI) or Machine Learning (ML) model according to an example embodiment.

FIG. 25 is a schematic flowchart of a method for monitoring an Artificial Intelligence (AI) or Machine Learning (ML) model according to an example embodiment.

FIG. 26 is a schematic flowchart of a method for monitoring an Artificial Intelligence (AI) or Machine Learning (ML) model according to an example embodiment.

FIG. 27 is a schematic flowchart of a method for monitoring an Artificial Intelligence (AI) or Machine Learning (ML) model according to an example embodiment.

FIG. 28 is a schematic flowchart of a method for monitoring an Artificial Intelligence (AI) or Machine Learning (ML) model according to an example embodiment.

FIG. 29 is a schematic flowchart of a method for monitoring an Artificial Intelligence (AI) or Machine Learning (ML) model according to an example embodiment.

FIG. 30 is a schematic flowchart of a method for monitoring an Artificial Intelligence (AI) or Machine Learning (ML) model according to an example embodiment.

FIG. 31 is a schematic flowchart of a method for monitoring an Artificial Intelligence (AI) or Machine Learning (ML) model according to an example embodiment.

FIG. 32 is a schematic flowchart of a method for monitoring an Artificial Intelligence (AI) or Machine Learning (ML) model according to an example embodiment.

FIG. 33 is a schematic flowchart of a method for monitoring an Artificial Intelligence (AI) or Machine Learning (ML) model according to an example embodiment.

FIG. 34 is a schematic flowchart of a method for monitoring an Artificial Intelligence (AI) or Machine Learning (ML) model according to an example embodiment.

FIG. 35 is a schematic flowchart of a method for monitoring an Artificial Intelligence (AI) or Machine Learning (ML) model according to an example embodiment.

FIG. 36 is a schematic diagram of an apparatus for monitoring an Artificial Intelligence (AI) or Machine Learning (ML) model according to an example embodiment.

FIG. 37 is a schematic diagram of an apparatus for monitoring an Artificial Intelligence (AI) or Machine Learning (ML) model according to an example embodiment.

FIG. 38 is a schematic diagram of a structure of a terminal according to an example embodiment.

FIG. 39 is a block diagram of a base station according to an example embodiment;

FIG. 40 is a schematic diagram of network architecture according to an example embodiment.

### DETAILED DESCRIPTION

Example embodiments will be described in detail herein, examples of which are shown in the accompanying drawings. When the following description refers to the drawings, the same numbers in different drawings represent the same or similar elements unless otherwise indicated. Implementations described in the following example embodiments do not represent all implementations consistent with the embodiments of the present disclosure. Instead, they are merely examples of apparatuses and methods consistent with some aspects of the embodiments of the present disclosure as detailed in the appended claims.

The terms used in the embodiments of the present disclosure are only for the purpose of describing specific embodiments and are not intended to limit the embodiments of the present disclosure. The singular forms “a”, “an” and “the” used in the embodiments of the present dis and the appended claims are also intended to include plural forms unless the context clearly indicates other meanings. It should also be understood that the term “and/or” used herein refers to and includes any or all possible combinations of one or more associated listed items.

It should be understood that although the terms first, second, third, etc. may be used to describe various information in the embodiments of the present disclosure, these pieces of information should not be limited to these terms. These terms are only used to distinguish the same type of information from each other. For example, without departing from the scope of the embodiments of the present disclosure, first information may also be referred to as second information, and similarly, second information may also be referred to as first information. Depending on the context, the word “if” as used herein may be interpreted as “at the time of” or “when” or “in response to determining”.

For the purpose of brevity and ease of understanding, the terms “greater than” or “less than” are used herein to represent magnitude relationship(s). However, those skilled in the art can understand that the term “greater than” also covers the meaning of “greater than or equal to”, and “less than” also covers the meaning of “less than or equal to”.

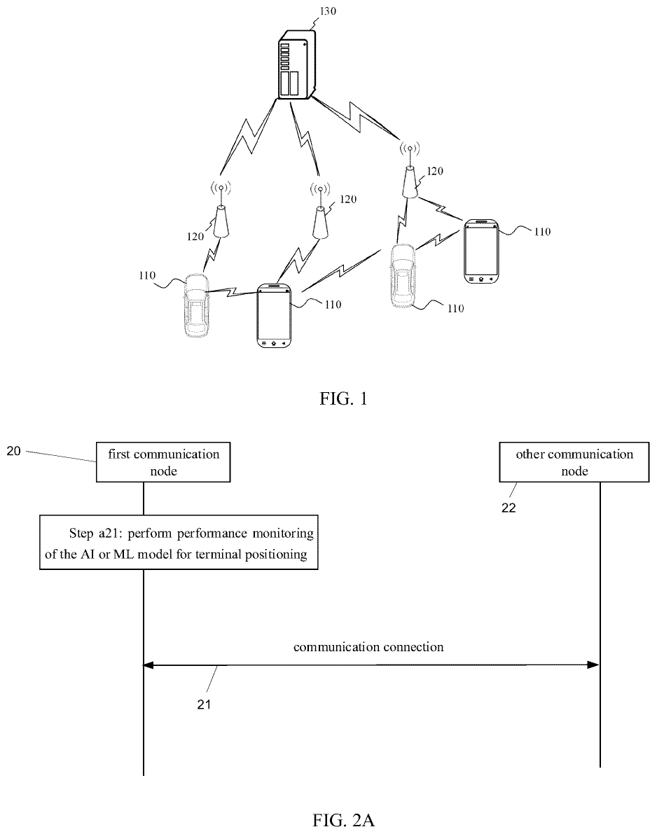

Referring to FIG. 1, it shows a structural diagram of a wireless communication system provided by an embodiment of the present disclosure. As shown in FIG. 1, the wireless communication system is a communication system based on a mobile communication technology. The wireless communication system may include: a number of pieces of user equipment 110 and a number of access network nodes. It should be noted that the access network node may be a base station 120. The user equipment 110 may be a terminal. Here, the terminal involved in the present disclosure may be but is not limited to a mobile phone, a wearable device, a vehicle-mounted terminal, a Road Side Unit (RSU), a smart home terminal, an industrial sensor device and/or a medical device, etc. In some embodiments, the terminal may be a Redcap terminal or a new air interface NR terminal of a predetermined version (for example, an R17 NR terminal).

The user equipment 110 may be a device that provides voice and/or data connectivity to a user. The user equipment 110 may communicate with one or more core networks via a Radio Access Network (RAN). The user equipment 110 may be Internet of Things user equipment, such as a sensor device, a mobile phone, and a computer with Internet of Things user equipment. For example, it may be a fixed, portable, pocket-sized, handheld, computer-built-in or vehicle-mounted device. For example, it may be a station (STA), a subscriber unit, a subscriber station, a mobile station, a mobile, a remote station, an access point, remote user equipment (remote terminal), an access user equipment (access terminal), a user terminal, a user agent, a user device, or user equipment. Alternatively, the user equipment 110 may also be a device of an unmanned aerial vehicle. Alternatively, the user equipment 110 may also be a vehicle-mounted device, for example, it may be an on-board computer with a wireless communication function, or wireless user equipment connected to an external on-board computer. Alternatively, the user equipment 110 may also be a roadside device, for example, a street lamp, a signal lamp or other roadside device with a wireless communication function, etc.

The base station 120 may be a network-side device in a wireless communication system. The wireless communication system may be a 4th generation mobile communication technology (4G) system, also known as a Long Term Evolution (LTE) system. Alternatively, the wireless communication system may be a 5G system, also known as a new air interface system or a 5G NR system. Alternatively, the wireless communication system may be a next generation system of a 5G system or other future wireless communication system(s). The access network in the 5G system may be referred to as New Generation-Radio Access Network (NG-RAN).

The base station 120 may be an evolved base station (eNB) adopted in a 4G system. Alternatively, the base station 120 may also be a base station (gNB) adopting a centralized distributed architecture in a 5G system. When the base station 120 adopts the centralized distributed architecture, it usually includes a Centralized unit (central unit, CU) and at least two Distributed Units (DUs). The centralized unit is provided with a protocol stack of a Packet Data Convergence Protocol (PDCP) layer, a Radio Link Control protocol (RLC) layer, a Media Access Control (MAC) layer. The distributed unit is provided with a physical (PHY) layer protocol stack. The specific implementation of the base station 120 is not limited in the embodiments of the present disclosure.

A wireless connection may be established between the base station 120 and the user equipment 110 via a radio air interface. In different implementations, the radio air interface is a radio air interface based on the 4th generation mobile communication network technology (4G) standard. Alternatively, the radio air interface is a radio air interface based on the 5th generation mobile communication network technology (5G) standard, for example, the radio air interface is a new air interface. Alternatively, the radio air interface may also be a radio air interface based on a next generation mobile communication network technology standard of 5G or other future wireless communication technology standard(s).

In some embodiments, an End to End (E2E) connection may also be established between the user equipment 110, such as Vehicle to Vehicle (V2V) communication, Vehicle to Infrastructure (V2I) communication, or Vehicle to Pedestrian (V2P) communication in Vehicle to everything (V2X) communication.

Here, the above-mentioned user equipment may be considered as a terminal device in the following embodiments.

In some embodiments, the wireless communication system may further include a core network device 130.

Several base stations 120 are respectively connected to the core network device 130. The core network device 130 may be a core network device in a wireless communication system. Here, the core network device may correspond to network function(s), for example communication node such as an Access and Mobility Management Function (AMF), a User Plane Function (UPF), and a Session Management Function (SMF), etc. The implementation form of the core network device 130 is not limited in the embodiments of the present disclosure.

In order to facilitate the understanding of those skilled in the art, the embodiments of the present disclosure list multiple implementations to clearly illustrate the technical solutions of the embodiments of the present disclosure. Of course, those skilled in the art can understand that the multiple embodiments provided by the embodiments of the present disclosure may be performed individually, or may be performed in combination with methods of other embodiments of the embodiments of the present disclosure, or the embodiments of the present disclosure, alone or in c, may be performed individually or in combination with some methods in other related art, and the embodiments of the present disclosure do not limit this.

First, application scenarios involved in the present disclosure are described:

In an embodiment, for AI-based positioning, there may be a plurality of AI models for positioning, and different AI models are applied to different positioning application scenarios.

In an embodiment, for different positioning application scenarios, different data sets are used to train AI models, thereby obtaining different AI models for different positioning application scenarios.

In an embodiment, an AI model for positioning may be deployed at a terminal, an access network device and a Location Management Function (LMF).

In an embodiment, an AI model for positioning includes: direct AI positioning, that is, directly obtaining location information of a terminal based on an AI positioning model; and indirect AI positioning, that is, a positioning measurement result obtained through an AI positioning model, for example, a measurement result of Reference Signal Time Difference (RSTD) or a measurement result of a time of arrival positioning method (TOA, Time of Arrival), and then a predetermined algorithm is used to calculate a location of a terminal based on the positioning measurement result obtained by the AI model.

In related art, it is needed to know the performance of the AI or ML model to determine whether a prediction result of the AI or ML model is accurate and to adjust the performance of the AI or ML model in time to achieve accurate positioning.

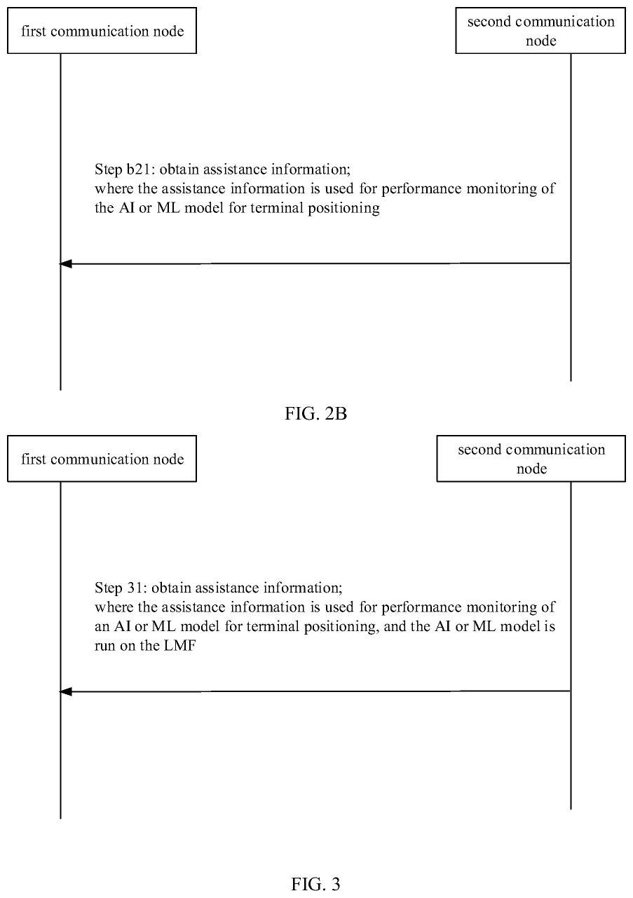

As shown in FIG. 2A, an embodiment provides a method for monitoring an Artificial Intelligence (AI) or Machine Learning (ML) model. The method is performed by a first communication node 20 having a communication connection 21 to an other communication node 22. The method includes:

In step a21, performance monitoring of the AI or ML model for terminal positioning is performed.

In the embodiment of the present disclosure, performance monitoring of the AI or ML model for terminal positioning is performed. Here, the first communication node can perform performance monitoring of the AI or ML model for terminal positioning. Compared with a situation where the performance monitoring of the AI or ML model for terminal positioning cannot be performed, a performance monitoring result of the AI or ML model can be known, and the performance of the AI or ML model can be adjusted in time, so that the AI or ML model is in a high-accuracy prediction state, thereby improving the accuracy of positioning.

Here, the terminal involved in the present disclosure may be, but is not limited to: a mobile phone, a wearable device, a vehicle-mounted terminal, a Road Side Unit (RSU), a smart home terminal, an industrial sensor device and/or a medical device, etc. In some embodiments, the terminal may be a Redcap terminal or a new air interface NR terminal of a predetermined version (for example, an R17 NR terminal).

The base station involved in the present disclosure may be various types of base stations, for example, a base station in a 3rd generation mobile communication (3G) network, a base station in a 4th generation mobile communication (4G) network, a base station in a 5th generation mobile communication (5G) network, or other evolved base station(s).

An LMF is involved in the present disclosure. Of course, the LMF may also be replaced by other evolved network function(s) having function(s) of the LMF, which is not limited here.

In an embodiment, assistance information is obtained. The assistance information is used for performance monitoring of the AI or ML model for terminal positioning. Performance monitoring of the AI or ML model for terminal positioning is performed based on the assistance information.

It should be noted that the assistance information may be information obtained from a communication node other than a second communication node, or information monitored by the first communication node itself, or information stored by the first communication node itself, which is not limited here.

In the embodiments of the present disclosure, the performance monitoring of the AI or ML model for terminal positioning is performed. Here, the first communication node can perform performance monitoring of the AI or ML model for terminal positioning. Compared with a situation where performance monitoring of the AI or ML model for terminal positioning cannot be performed, a performance monitoring result of the AI or ML model can be obtained, and the performance of the AI or ML model can be adjusted in time, so that the AI or ML model is in a high-accuracy prediction state, thereby improving the accuracy of positioning.

It should be noted that those skilled in the art can understand that the methods provided in the embodiments of the present disclosure may be performed individually or may be performed together with some methods in the embodiments of the present disclosure or some methods in related art.

As shown in FIG. 2B, an embodiment provides a method for monitoring an Artificial Intelligence (AI) or Machine Learning (ML) model. The method is performed by a first communication node. The method includes:
In step b21, assistance information is obtained.

The assistance information is used for performance monitoring of the AI or ML model for terminal positioning.

Here, the terminal involved in the present disclosure may be, but is not limited to: a mobile phone, a wearable device, a vehicle-mounted terminal, a Road Side Unit (RSU), a smart home terminal, an industrial sensor device and/or a medical device, etc. In some embodiments, the terminal may be a Redcap terminal or a new air interface NR terminal of a predetermined version (for example, an R17 NR terminal).

The base stations involved in the present disclosure may be various types of base stations, for example, a base station in a 3rd generation mobile communication (3G) network, a base station in a 4th generation mobile communication (4G) network, a base station in a 5th generation mobile communication (5G) network, or other evolved base station(s).

An LMF is involved in the present disclosure. Of course, the LMF may also be replaced by other evolved network function(s) having function(s) of the LMF, which is not limited here.

In an implementation, assistance information is obtained. The assistance information is used for performance monitoring of the AI or ML model for terminal positioning. Based on the assistance information, monitoring of the AI or ML model is performed to obtain a monitoring result. It should be noted that the monitoring of the AI or ML model may be comparing a positioning result determined based on the assistance information with a positioning result obtained by the AI or ML model. The positioning result may include: terminal location information and/or a measurement result obtained by measuring a positioning reference signal.

It should be noted that those skilled in the art can understand that the methods provided in the embodiments of the present disclosure may be performed individually or may be performed together with some methods in the embodiments of the present disclosure or some methods in related art.

As shown in FIG. 3, an embodiment provides a method for monitoring an Artificial Intelligence (AI) or Machine Learning (ML) model. The method is performed by an LMF. The method includes:

In step 31, assistance information is obtained.

The assistance information is used for performance monitoring of the AI or ML model for terminal positioning. The AI or ML model is run on the LMF.

In an embodiment, the assistance information sent by the base station is received. The assistance information includes: a measurement result determined by an uplink positioning reference signal, or a measurement result of an uplink positioning reference signal of a terminal. The assistance information is used for performance monitoring of the AI or ML model for terminal positioning. Optionally, the uplink positioning reference signal may be specified by the LMF, or the terminal may be specified by the LMF.

In an embodiment, the measurement result determined based on the uplink positioning reference signal may include at least one of the following result(s): Reference Signal Receiving Power (RSRP), Reference Signal Received Path Power (RSRPP), Channel Impulse Response (CIR), Arrival of Angle (AOA), Angle of Departure (AOD) or Signal to Interference plus Noise Ratio (SINR).

In an embodiment, request information for requesting the assistance information is sent to the base station. The assistance information sent by the base station is received. The assistance information includes: a measurement result determined by an uplink positioning reference signal, or a measurement result of an uplink positioning reference signal of a terminal. The assistance information is used for performance monitoring of the AI or ML model for terminal positioning. The request information may include the requested specific assistance information, such as, requesting the measurement result determined by the uplink positioning reference signal. The request information may include at least one of the following result(s): RSRP, RSRPP, CIR, AOA, AOD and SINR. Optionally, the request information may also include a specified uplink positioning reference signal or a specified UE. After the base station receives the request information, the base station measures the specified UE or the specified uplink positioning reference signal.

In an embodiment, the assistance information sent by a terminal is received. The assistance information includes: a measurement result determined by a downlink positioning reference signal. The assistance information is used for performance monitoring of the AI or ML model for terminal positioning. Optionally, the downlink positioning reference signal may be specified by the LMF.

In an embodiment, the measurement result determined based on the downlink positioning reference signal includes at least one of the following result(s): RSRP, RSRPP, CIR, SINR, Reference Signal Time Difference (RSTD) and Time of Arrival (TOA).

In an embodiment, request information for requesting the assistance information is sent to the terminal. The assistance information sent by the terminal is received. The assistance information includes: a measurement result determined by a specified a downlink positioning reference signal. The assistance information is used for performance monitoring of the AI or ML model for terminal positioning. The request information may include the requested specific assistance information, such as requesting a measurement result determined by a downlink positioning reference signal. The request information may include at least one of the following result(s): RSRP, RSRPP, CIR, SINR, RSTD and TOA. Optionally, the request information may also include the specified downlink positioning reference signal or a specified UE. After the terminal receives the request information, the terminal measures the specified UE or the specified downlink positioning reference signal.

In an embodiment, the assistance information sent by a Positioning Reference Unit (PRU) is received. The assistance information includes: location information of the PRU and a measurement result determined based on a positioning reference signal. The assistance information is used for performance monitoring of the AI or ML model for terminal positioning. Optionally, the positioning reference signal may be specified by the LMF.

In an embodiment, the measurement result determined based on the positioning reference signal includes at least one of the following result(s): RSRP, RSRPP, CIR, SINR, RSTD and TOA.

In an embodiment, a distance between the location of the PRU and a terminal being positioned is within a predetermined range.

In an embodiment, request information for requesting the assistance information is sent to the PRU. The assistance information sent by the Positioning Reference Unit (PRU) is received. The assistance information includes: the location information of the PRU and the measurement result determined based on the positioning reference signal. The assistance information is used for performance monitoring of the AI or ML model for terminal positioning. The request information may include the requested specific assistance information. Optionally, the request information may also include a specified positioning reference signal. After the PRU receives the request information, the PRU measures the specified positioning reference signal.

In an embodiment, the assistance information sent by a Network Data Analytics Function (NWDAF) is received. The assistance information is used to indicate: information that a location of a terminal meets an expectation or information that the location of the terminal does not meet the expectation. The assistance information is used for performance monitoring of the AI or ML model for terminal positioning.

In an embodiment, request information for requesting the assistance information is sent to the NWDAF. The assistance information sent by the Network Data Analytics Function (NWDAF) is received. The assistance information is used to indicate: information that a location of a terminal meets an expectation or information that the location of the terminal does not meet the expectation. The assistance information is used for performance monitoring of the AI or ML model for terminal positioning. The request information may include the requested specific assistance information. Optionally, the request information may indicate the content of the information to be requested, for example, information that a location of a terminal meets an expectation or information that the location of the terminal does not meet the expectation.

In an embodiment of the present disclosure, assistance information is obtained. The assistance information is used for performance monitoring of the AI or ML model for terminal positioning. Here, the first communication node can obtain the assistance information for performance monitoring of the AI or ML model for terminal positioning. After obtaining the assistance information, the AI or ML model can be monitored based on the assistance information. Compared with a situation where the performance of the AI or ML model for terminal positioning cannot be detected based on the assistance information, a performance monitoring result of the AI or ML model can be obtained, and the performance of the AI or ML model can be adjusted in time, so that the AI or ML model is in a high-accuracy prediction state, thereby improving the accuracy of positioning.

It should be noted that those skilled in the art can understand that the methods provided in the embodiments of the present disclosure may be performed individually or may be performed together with some methods in the embodiments of the present disclosure or some methods in related art.

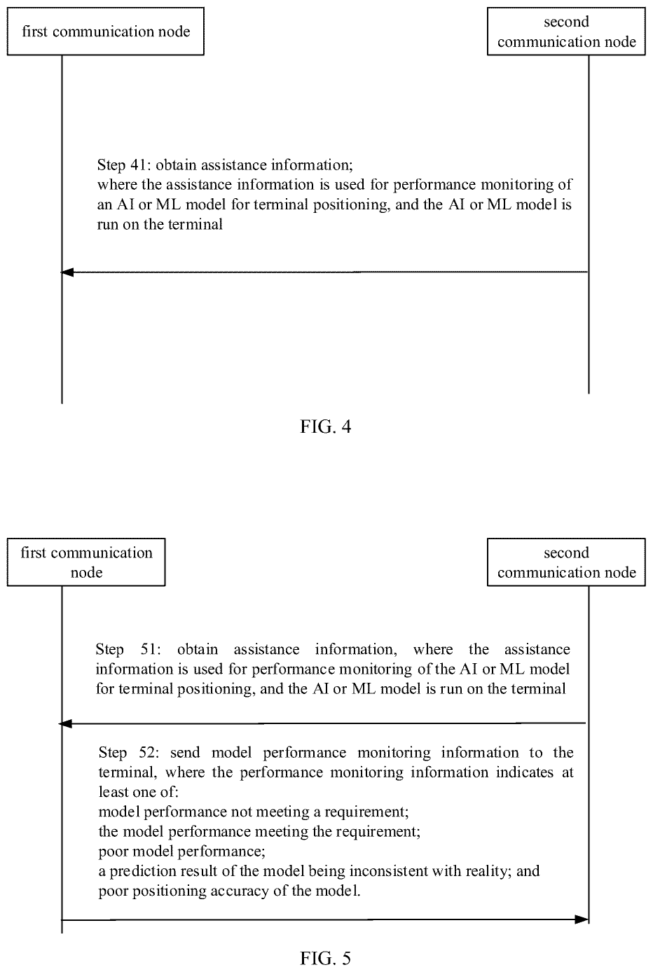

As shown in FIG. 4, an embodiment provides a method for monitoring an Artificial Intelligence (AI) or Machine Learning (ML) model. The method is performed by an LMF. The method includes:

In step 41, assistance information is obtained.

The assistance information is used for performance monitoring of the AI or ML model for terminal positioning. The AI or ML model is run on a terminal.

In an embodiment, the assistance information sent by the terminal is received. The assistance information includes: a terminal location result predicted by the AI or ML model and a terminal location result determined by other positioning method(s) other than the model; or, a positioning signal measurement result predicted by the AI or ML model and a positioning reference signal measurement result obtained by the terminal by performing an actual positioning reference signal measurement. The assistance information is used for performance monitoring of the AI or ML model for terminal positioning. The AI or ML model is run on the terminal. Optionally, the positioning reference signal may be specified by the LMF, or the terminal is specified by the LMF.

In an embodiment, the other positioning method(s) mentioned above may be positioning method(s) that is(are) not based on an AI or ML model, such as Global Navigation Satellite System (GNSS), Downlink Time Difference Of Arrival (DL-TDOA), or DL-AOD, etc.

In an embodiment, the positioning reference signal measurement result obtained by the terminal by performing the actual positioning reference signal measurement may be a Reference Signal Time Difference (RSTD) or TOA, etc.

In an embodiment, request information for requesting the assistance information is sent to the terminal. The assistance information sent by the terminal is received. The assistance information includes: a terminal location result predicted by the AI or ML model and a terminal location result determined by other positioning method(s) other than the model; or, a positioning signal measurement result predicted by the AI or ML model and a positioning reference signal measurement result obtained by the terminal by performing an actual positioning reference signal measurement. The assistance information is used for performance monitoring of the AI or ML model for terminal positioning. The AI or ML model is run on the terminal. The request information may include the requested specific assistance information, such as requesting the measurement result determined by the positioning reference signal, which may include at least one of the following result(s): RSTD and TOA. Optionally, the request information may also include a specified positioning reference signal, or a specified UE. After the terminal receives the request information, the terminal measures the specified UE or the specified positioning reference signal.

In an embodiment, the assistance information sent by a PRU is received. The assistance information includes: location information of the PRU and a measurement result obtained by measuring a positioning reference signal. The assistance information is used for performance monitoring of the AI or ML model for the terminal positioning. Optionally, the positioning reference signal may be specified by the LMF, or the terminal is specified by the LMF.

In an embodiment, the measurement result obtained by measuring the positioning reference signal includes at least one of: RSPP, RSRPP, CIR, RSTD and TOA.

In an embodiment, a distance between the location of the PRU and a terminal being positioned is within a predetermined range.

In an embodiment, request information for requesting the assistance information is sent to the PRU. The assistance information sent by the PRU is received. The assistance information includes: the location information of the PRU and the measurement result obtained by measuring the positioning reference signal. The assistance information is used for performance monitoring of the AI or ML model for terminal positioning. The request information may include the requested specific assistance information, such as requesting the measurement result determined by the positioning reference signal, which may include at least one of the following result(s): RSRP, RSRPP, CIR, RSTD and TOA. Optionally, the request information may also include a specified positioning reference signal. After the terminal receives the request information, the terminal measures the specified positioning reference signal.

In an embodiment, the assistance information sent by a NWDAF is received. The assistance information is used to indicate: information that a location of a terminal meets an expectation or information that the location of the terminal does not meet the expectation. The assistance information is used for performance monitoring of the AI or ML model for terminal positioning.

In an embodiment, request information for requesting the assistance information is sent to the NWDAF. The assistance information sent by the NWDAF is received. The assistance information is used to indicate: information that a location of a terminal meets an expectation or information that the location of the terminal does not meet the expectation. The assistance information is used for performance monitoring of the AI or ML model for terminal positioning. The request information includes the requested specific assistance information. Optionally, the request information may indicate the content of information that needs to be obtained, for example, information that a location of a terminal meets an expectation or information that the location of the terminal does not meet the expectation.

In an embodiment, assistance information is obtained. The assistance information is used for performance monitoring of the AI or ML model for terminal positioning. The AI or ML model is run on a terminal. Model performance monitoring information is sent to the terminal. The performance monitoring information indicates at least one of:
model performance not meeting a requirement;
the model performance meeting the requirement;
poor model performance;
a prediction result of the model being inconsistent with reality; and
poor positioning accuracy of the model.

Optionally, the model performance not meeting a requirement may refer to that: a location of a UE or a positioning measurement result obtained by the AI or ML model does not meet a requirement for UE positioning. The poor model performance may refer to that the positioning accuracy of the location of a UE obtained by the AI or ML model is low. The prediction result of the model being inconsistent with reality may refer to that: there is a large error between the location of a UE or a positioning measurement result obtained by the AI or ML model and an actual location of the UE or an actual positioning result. The poor positioning accuracy of the model may refer to that: the positioning accuracy of the location of a UE obtained by the AI or ML model is low.

In an embodiment, assistance information is obtained. The assistance information is used for performance monitoring of the AI or ML model for terminal positioning. The AI or ML model is run on the terminal. Operation information is sent to the terminal;
the operation information indicates at least one of:
information indicating the terminal to stop using the model;
information indicating the terminal to use another model; and
information indicating the terminal to update a parameter of the model.

In an embodiment, operation information sent by the LMF is received; in response to the operation information indicating the information indicating the terminal to stops using the model, the terminal stops using the model.

In an embodiment, operation information sent by the LMF is received; in response to the operation information indicating the information indicating the terminal to use another model, the terminal replaces the current model with another model.

In an embodiment, operation information sent by the LMF is received; in response to the operation information indicating the information indicating the terminal to update a parameter of the model, the terminal updates the parameter of the model.

It should be noted that those skilled in the art can understand that the methods provided in the embodiments of the present disclosure may be performed individually or may be performed together with some methods in the embodiments of the present disclosure or some methods in related art.

As shown in FIG. 5, an embodiment provides a method for monitoring an Artificial Intelligence (AI) or Machine Learning (ML) model. The method is performed by an LMF. The method includes:

In step 51, assistance information is obtained. The assistance information is used for performance monitoring of the AI or ML model for terminal positioning. The AI or ML model is run on the terminal. It should be noted that in the embodiment of the present disclosure, step 51 may be optional, and the embodiment of the present disclosure may only include step 52.

In step 52, model performance monitoring information is sent to the terminal. The performance monitoring information indicates at least one of:
model performance not meeting a requirement;
the model performance meeting the requirement;
poor model performance;
a prediction result of the model being inconsistent with reality; and
poor positioning accuracy of the model.

Model information of supported model(s) may refer to that: there may be information of multiple AI or ML models for positioning, and the terminal may support a part of the AI or ML models, or support all of the AI or ML models, and thus the terminal needs to indicate specific AI or ML model(s) that can be monitored. In addition, functions of different AI or ML models may also be different. For example, some AI or ML models can predict terminal location(s), while some AI or ML models can only predict positioning measurement result(s). Therefore, the terminal also needs to indicate that it supports monitoring of AI or ML model(s) that can predict terminal location(s), or supports monitoring of AI or ML model(s) that can predict positioning measurement result(s).

It should be noted that those skilled in the art can understand that the methods provided in the embodiments of the present disclosure may be performed individually or may be performed together with some methods in the embodiments of the present disclosure or some methods in related art.

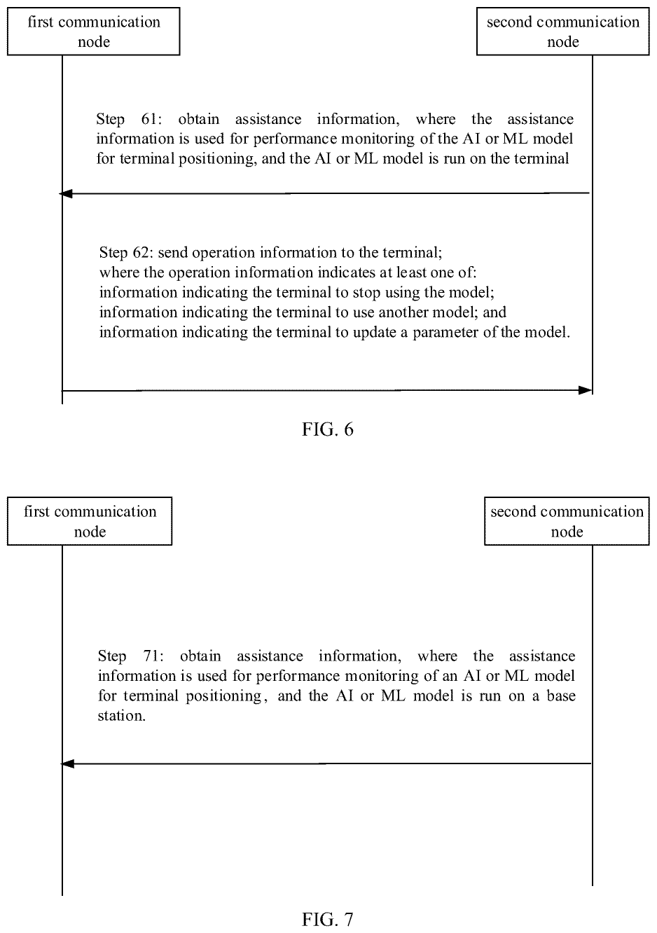

As shown in FIG. 6, an embodiment provides a method for monitoring an Artificial Intelligence (AI) or Machine Learning (ML) model. The method is performed by an LMF. The method includes:

In step 61, assistance information is obtained. The assistance information is used for performance monitoring of the AI or ML model for terminal positioning. The AI or ML model is run on a terminal. It should be noted that in the embodiment of the present disclosure, step 61 may be optional, and the embodiment of the present disclosure may only include step 62.

In step 62, operation information is sent to the terminal.

The operation information indicates at least one of:
information indicating the terminal to stop using the model;
information indicating the terminal to use another model; and
information indicating the terminal to update a parameter of the model.

In an embodiment, operation information sent by the LMF is received; in response to the operation information indicating the information indicating the terminal to stop using the model, the terminal stops using the model.

In an embodiment, operation information sent by the LMF is received; in response to the operation information indicating the information indicating the terminal to use another model, the terminal replaces the current model with another model.

In an embodiment, operation information sent by the LMF is received; in response to the operation information indicating the information indicating the terminal to update a parameter of the model, the terminal update the parameter of the model.

It should be noted that those skilled in the art can understand that the methods provided in the embodiments of the present disclosure may be performed individually or may be performed together with some methods in the embodiments of the present disclosure or some methods in related art.

As shown FIG. 7, an embodiment provides a method for monitoring an Artificial Intelligence (AI) or Machine Learning (ML) model. The method is performed by an LMF. The method includes:

In step 71, assistance information is obtained. The assistance information is used for performance monitoring of the AI or ML model for terminal positioning. The AI or ML model is run on a base station.

In an embodiment, the assistance information sent by the base station is received. The assistance information includes: a positioning reference signal measurement result predicted by the AI or ML model and a positioning reference signal measurement result obtained by the base station by performing an actual positioning reference signal measurement. The assistance information is used for performance monitoring of the AI or ML model for terminal positioning. Optionally, the positioning reference signal may be specified by the LMF.

In an embodiment, the positioning reference signal measurement result obtained by the base station by performing the actual positioning reference signal measurement includes at least one of: AOA, AOD and flight time.

In an embodiment, request information for requesting the assistance information is sent to the base station. The assistance information sent by the base station is received. The assistance information includes: a positioning reference signal measurement result predicted by the AI or ML model and a positioning reference signal measurement result obtained by the base station by performing an actual positioning reference signal measurement. The assistance information is used for performance monitoring of the AI or ML model for terminal positioning. The request information may include the requested specific assistance information, such as requesting the measurement result determined by the positioning reference signal, which may include at least one of the following result(s): AOA, AOD and flight time. Optionally, the request information may also include a specified positioning reference signal, or a specified UE. After the terminal receives the request information, the terminal measures the specified UE or the specified positioning reference signal.

In an embodiment, the assistance information sent by a PRU is received. The assistance information is used to indicate: location information of the PRU and a measurement result obtained by measuring a positioning reference signal. The assistance information is used for performance monitoring of the AI or ML model for terminal positioning. Optionally, the positioning reference signal may be specified by the LMF.

In an embodiment, request information for requesting the assistance information is sent to the PRU. The assistance information sent by the PRU is received. The assistance information is used to indicate: location information of the PRU and a measurement result obtained by measuring a positioning reference signal. The assistance information is used for performance monitoring of the AI or ML model for terminal positioning. The request information may include the requested specific assistance information, such as requesting the measurement result obtained by the positioning reference signal. Optionally, the request information may also include a specified positioning reference signal. After the PRU receives the request information, the PRU measures the specified positioning reference signal.

In an embodiment, assistance information is obtained. The assistance information is used for performance monitoring of the AI or ML model for terminal positioning. The AI or ML model is run on a base station. Model performance monitoring information is sent to the base station. The performance monitoring information indicates at least one of:
model performance not meeting a requirement;
the model performance meeting the requirement;
poor model performance;
a prediction result of the model being inconsistent with reality; and
poor positioning accuracy of the model.

Model information of supported model(s) may refer to that: there may be information of multiple AI or ML model(s) for positioning, and the terminal may support a part of the AI or ML models, or support all of the AI or ML models, and thus the terminal needs to indicate specific AI or ML model(s) that can be monitored. In addition, functions of different AI or ML models may also be different. For example, some AI or ML models can predict terminal location(s), while some AI or ML models can only predict positioning measurement result(s). Therefore, the terminal also needs to indicate that it supports monitoring of AI or ML model(s) that can predict terminal location(s), or supports monitoring of AI or ML model(s) that can predict positioning measurement result(s).

In an embodiment, assistance information is obtained. The assistance information is used for performance monitoring of the AI or ML model for terminal positioning. The AI or ML model is run on a base station. Operation information is sent to the base station. The operation information indicates at least one of:
information indicating the base station to stop using the model;
information indicating the base station to use another model; and
information indicating the base station to update a parameter of the model.

In an embodiment, operation information sent by an LMF is received; in response to the operation information indicating the information indicating the base station to stop using the model, the base station stops using the model.

In an embodiment, operation information sent by the LMF is received; in response to the operation information indicating the information indicating the base station to use another model, the base station replaces the current model with another model.

In an embodiment, operation information sent by the LMF is received; in response to the operation information indicating the information indicating the base station to update a parameter of the model, the base station updates the parameter of the model.

It should be noted that those skilled in the art can understand that the methods provided in the embodiments of the present disclosure may be performed individually or may be performed together with some methods in the embodiments of the present disclosure or some methods in related art.

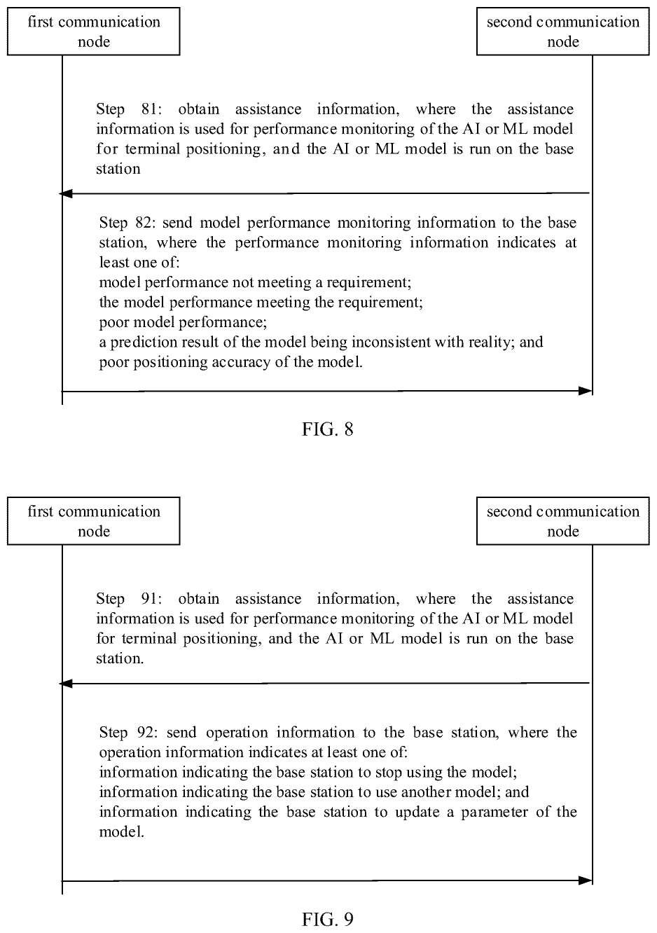

As shown in FIG. 8, an embodiment provides a method for monitoring an Artificial Intelligence (AI) or Machine Learning (ML) model. The method is performed by an LMF. The method includes:

In step 81, assistance information is obtained. The assistance information is used for performance monitoring of the AI or ML model for terminal positioning. The AI or ML model is run on a base station. It should be noted that in the embodiment of the present disclosure, step 81 may be optional, and the embodiment of the present disclosure may only include step 82.

In step 82, model performance monitoring information is sent to the base station. The performance monitoring information indicates at least one of:
model performance not meeting a requirement;
the model performance meeting the requirement;
poor model performance;
a prediction result of the model being inconsistent with reality; and
poor positioning accuracy of the model.

Model information of supported model(s) may refer to that: there may be information of multiple AI or ML models for positioning, and the terminal may support a part of the AI or ML models, or support all of the AI or ML models, and thus the terminal needs to indicate specific AI or ML model(s) that can be monitored. In addition, functions of different AI or ML models may also be different. For example, some AI or ML models can predict terminal location(s), while some AI or ML models can only predict positioning measurement result(s). Therefore, the terminal also needs to indicate that it supports monitoring of AI or ML model(s) that can predict terminal location(s), or supports monitoring of AI or ML model(s) that can predict positioning measurement result(s).

It should be noted that those skilled in the art can understand that the methods provided in the embodiments of the present disclosure may be performed individually or may be performed together with some methods in the embodiments of the present disclosure or some methods in related art.

As shown in FIG. 9, an embodiment provides a method for monitoring an Artificial Intelligence (AI) or Machine Learning (ML) model. The method is performed by an LMF. The method includes:

In step 91, assistance information is obtained. The assistance information is used for performance monitoring of the AI or ML model for terminal positioning. The AI or ML model is run on a base station. It should be noted that in the embodiment of the present disclosure, step 91 may be optional, and the embodiment of the present disclosure may only include step 92.

In step 92, operation information is sent to the base station. The operation information indicates at least one of:
information indicating the base station to stop using the model;
information indicating the base station to use another model; and
information indicating the base station to update a parameter of the model.

In an embodiment, operation information sent by the LMF is received; in response to the operation information indicating the information indicating the base station to stop using the model, the base station stops using the model.

In an embodiment, operation information sent by the LMF is received; in response to the operation information indicating the information indicating the base station to use another model, the base station replaces the current model with another model.

In an embodiment, operation information sent by the LMF is received; in response to the operation information indicating the information indicating the base station to update a parameter of the model, the base station updates the parameter of the model.

It should be noted that those skilled in the art can understand that the methods provided in the embodiments of the present disclosure may be performed individually or may be performed together with some methods in the embodiments of the present disclosure or some methods in related art.

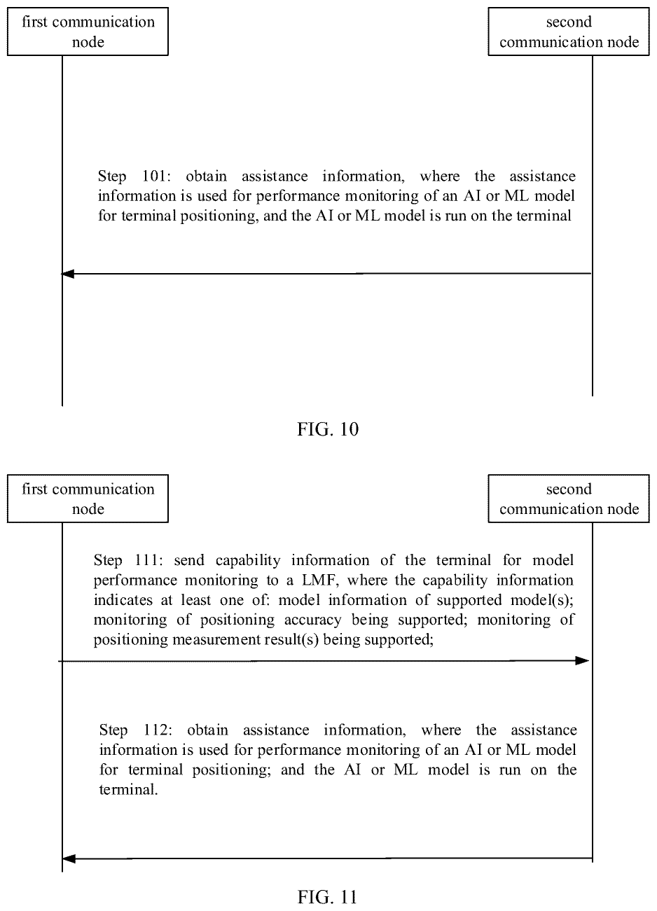

As shown in FIG. 10, an embodiment provides a method for monitoring an Artificial Intelligence (AI) or Machine Learning (ML) model. The method is performed by a terminal. The method includes:

In step 101, assistance information is obtained. The assistance information is used for performance monitoring of an AI or ML model for terminal positioning. The AI or ML model is run on the terminal.

In an embodiment, capability information of the terminal for model performance monitoring is sent to an LMF. The capability information indicates at least one of: model information of supported model(s); monitoring of positioning accuracy being supported; monitoring of positioning measurement result(s) being supported. Assistance information is obtained. The assistance information is used for performance monitoring of the AI or ML model for terminal positioning. The AI or ML model is run on the terminal. The capability information may be a LTE Positioning Protocol (LPP) support capability.

The model information of the supported model(s) may refer to that: there may be information of multiple AI or ML models for positioning, and the terminal may support a part of the AI or ML models, or support all of the AI or ML models, and thus the terminal needs to indicate specific AI or ML model(s) that can be monitored. In addition, functions of different AI or ML models may also be different. For example, some AI or ML models can predict terminal location(s), while some AI or ML models can only predict positioning measurement result(s). Therefore, the terminal also needs to indicate that it supports monitoring of AI or ML model(s) that can predict terminal location(s), or supports monitoring of AI or ML model(s) that can predict positioning measurement result(s).

In an embodiment, request information from the LMF is received. The request information is used to request the capability information. The capability information of the terminal for model performance monitoring is sent to the LMF. The capability information indicates at least one of: model information of supported model(s); monitoring of positioning accuracy being supported; monitoring of positioning measurement result(s) being supported. The request information may include the requested specific assistance information, such as requesting at least one of: model information of supported model(s), monitoring of positioning accuracy being supported, and monitoring of positioning measurement result(s) being supported.

In an embodiment, assistance information sent by an LMF is received. The assistance information is used to include at least one of: a distance between the terminal and the base station and a positioning measurement result of the terminal; location information of the terminal and the positioning measurement result of the terminal; location information of a PRU and a positioning measurement result of the PRU; and historical location information of the terminal and a measurement result for determining the historical location information of the terminal. The assistance information is used for performance monitoring of the AI or ML model for terminal positioning. The AI or ML model is run on the terminal.

In an embodiment, the positioning measurement result of the terminal includes at least one of: RSRP, RSRPP, SINR, Signal to Noise Ratio (SNR), TOA and RSTD.

In an embodiment, the positioning measurement result of the PRU includes at least one of: RSRP, RSRPP, SINR, SNR, TOA and RSTD.

In an embodiment, request information for requesting the assistance information is sent to the LMF. The request information indicates at least one of: an AI or ML model that needs to be detected; and an application scenario of the AI or ML model. The assistance information sent by the LMF is received. The assistance information is used to include at least one of: a distance between the terminal and the base station and the positioning measurement result of the terminal; the location information of the terminal and the positioning measurement result of the terminal; the location information of the PRU and the positioning measurement result of the PRU; and the historical location information of the terminal and the measurement result for determining the historical location information of the terminal. The assistance information is used for performance monitoring of the AI or ML model for terminal positioning. The AI or ML model is run on the terminal. The request information may include the requested specific assistance information, such as requesting the positioning measurement result of the terminal, and may include at least one of the following result(s): RSRP, RSRPP, SINR, Signal to Noise Ratio (SNR), TOA and RSTD. Optionally, the request information may also include a specified positioning reference signal. After the terminal receives the request information, the terminal measures the specified positioning reference signal.

In an embodiment, request information for monitoring the model sent by the LMF is received. The request information indicates a monitoring period for monitoring the model.

In an embodiment, assistance information is obtained. The assistance information is used for performance monitoring of the AI or ML model for terminal positioning. The AI or ML model is run on the terminal. Model performance monitoring information is sent to the LMF. The performance monitoring information indicates at least one of:
model performance not meeting a requirement;
the model performance meeting the requirement;
poor model performance;
a prediction result of the model being inconsistent with reality; and
poor positioning accuracy of the model.

Model information of supported model(s) may refer to that: there may be information of multiple AI or ML models for positioning, and the terminal may support a part of the AI or ML models, or support all of the AI or ML models, and thus the terminal needs to indicate specific AI or ML model(s) that can be monitored. In addition, functions of different AI or ML models may also be different. For example, some AI or ML models can predict terminal location(s), while some AI or ML models can only predict positioning measurement result(s). Therefore, the terminal also needs to indicate that it supports monitoring of AI or ML model(s) that can predict terminal location(s), or supports monitoring of AI or ML model(s) that can predict positioning measurement result(s).

In an embodiment, assistance information is obtained. The assistance information is used for performance monitoring of an AI or ML model for terminal positioning. The AI or ML model is run on the terminal. Operation information sent by an LMF is received. The operation information indicates at least one of:
information indicating the terminal to stop using the model;
information indicating the terminal to use another model; and
information indicating the terminal to update a parameter of the model.

In an embodiment, operation information sent by the LMF is received; in response to the operation information indicating the information indicating the terminal to stop using the model, the terminal stops using the model.

In an embodiment, operation information sent by the LMF is received; in response to the operation information indicating the information indicating the terminal to use another model, the terminal replaces the current model with another model.

In an embodiment, operation information sent by the LMF is received; in response to the operation information indicating the information indicating the terminal to update the parameter of the model, the terminal updates the parameter of the model.

It should be noted that those skilled in the art can understand that the methods provided in the embodiments of the present disclosure may be performed individually or may be performed together with some methods in the embodiments of the present disclosure or some methods in related art.

As shown in FIG. 11, an embodiment provides a method for monitoring an Artificial Intelligence (AI) or Machine Learning (ML) model. The method is performed by a terminal. The method includes:

In step 111, capability information of the terminal for model performance monitoring is sent to an LMF. The capability information indicates at least one of: model information of supported model(s); monitoring of positioning accuracy being supported; monitoring of positioning measurement result(s) being supported.

Optionally, the method further includes step 112: obtaining assistance information. The assistance information is used for performance monitoring of an AI or ML model for terminal positioning. The AI or ML model is run on the terminal.

It should be noted that those skilled in the art can understand that the methods provided in the embodiments of the present disclosure may be performed individually or may be performed together with some methods in the embodiments of the present disclosure or some methods in related art.

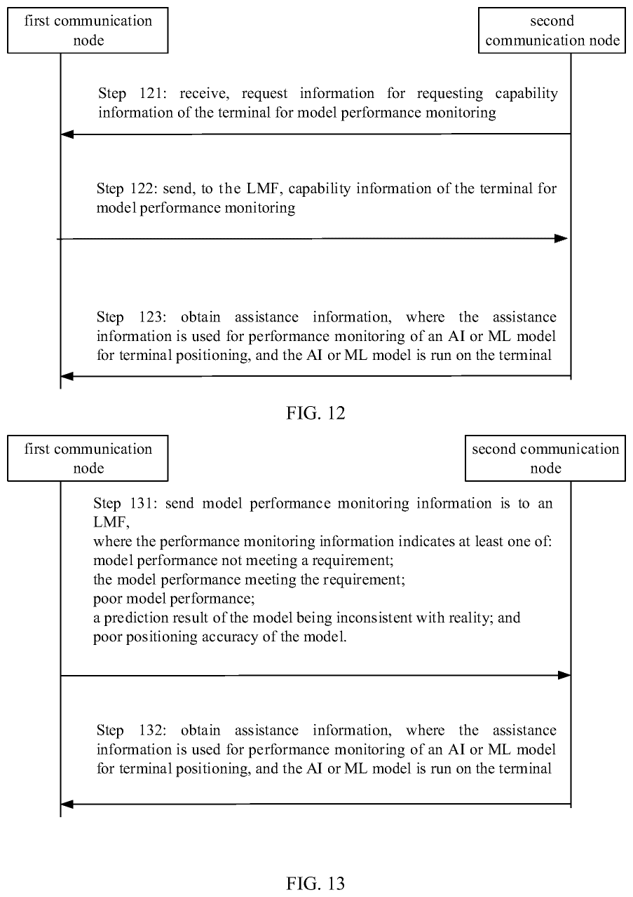

As shown in FIG. 12, an embodiment provides a method for monitoring an Artificial Intelligence (AI) or Machine Learning (ML) model. The method is performed by a terminal. The method includes:

In step 121, request information for requesting capability information of the terminal for model performance monitoring sent from an LMF is received. It should be noted that, in the embodiment of the present disclosure, step 121 may be optional, and the embodiment of the present disclosure may only include step 122.

In step 122, the capability information of the terminal for model performance monitoring is sent to the LMF.

The capability information indicates at least one of:
model information of supported model(s);
monitoring of positioning accuracy being supported;
monitoring of positioning measurement result(a) being supported.

In step 123, assistance information is obtained. The assistance information is used for performance monitoring of an AI or ML model for terminal positioning. The AI or ML model is run on the terminal.

In an embodiment, request information from the LMF is received. The request information is used for requesting the capability information. The capability information of the terminal for model performance monitoring is sent to the LMF. The capability information indicates at least one of: model information of supported model(s); monitoring of positioning accuracy being supported; monitoring of positioning measurement result(s) being supported. Assistance information is obtained. The assistance information is used for performance monitoring of the AI or ML model for terminal positioning. The AI or ML model is run on the terminal.

It should be noted that those skilled in the art can understand that the methods provided in the embodiments of the present disclosure may be performed individually or may be performed together with some methods in the embodiments of the present disclosure or some methods in related art.

As shown in FIG. 13, an embodiment provides a method for monitoring an Artificial Intelligence (AI) or Machine Learning (ML) model. The method is performed by a terminal. The method includes:

In step 131, model performance monitoring information is sent to an LMF.

The performance monitoring information indicates at least one of:
model performance not meeting a requirement;
the model performance meeting the requirement;
poor model performance;
a prediction result of the model being inconsistent with reality; and
poor positioning accuracy of the model.

Model information of supported model(s) may refer to that: there may be information of multiple AI or ML models for positioning, and the terminal may support a part of the AI or ML models, or support all of the AI or ML models, and thus the terminal needs to indicate specific AI or ML model(s) that can be monitored. In addition, functions of different AI or ML models may also be different. For example, some AI or ML models can predict terminal location(s), while some AI or ML models can only predict positioning measurement result(s). Therefore, the terminal also needs to indicate that it supports monitoring of AI or ML model(s) that can predict terminal location(s), or supports monitoring of AI or ML model(s) that can predict positioning measurement result(s).

Optionally, the method further includes step 132: obtaining assistance information. The assistance information is used for performance monitoring of the AI or ML model for terminal positioning. The AI or ML model is run on the terminal.

It should be noted that those skilled in the art can understand that the methods provided in the embodiments of the present disclosure may be performed individually or may be performed together with some methods in the embodiments of the present disclosure or some methods in related art.

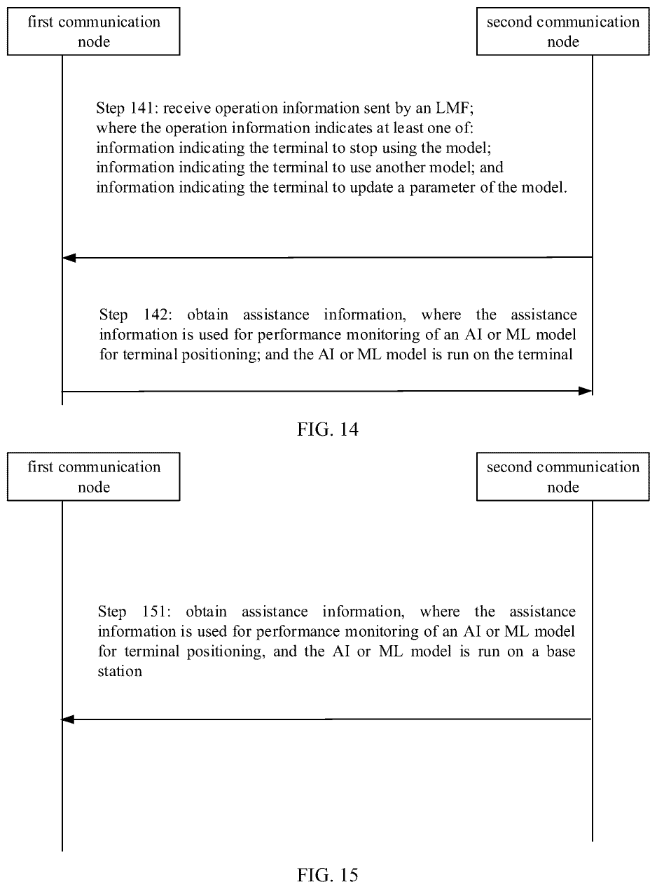

As shown in FIG. 14, an embodiment provides a method for monitoring an Artificial Intelligence (AI) or Machine Learning (ML) model. The method is performed by a terminal. The method includes:

In step 141, operation information sent by an LMF is received.

The operation information indicates at least one of:
information indicating the terminal to stop using the model;
information indicating the terminal to use another model; and
information indicating the terminal to update a parameter of the model.

Optionally, the method further includes step 142: obtaining assistance information. The assistance information is used for performance monitoring of the AI or ML model for terminal positioning. The AI or ML model is run on the terminal.

In an embodiment, operation information sent by the LMF is received; in response to the operation information indicating the information indicating the terminal to stop using the model, the terminal stops using the model.

In an embodiment, operation information sent by the LMF is received; in response to the operation information indicating the information indicating the terminal to use another model, the terminal replaces the current model with another model.

In an embodiment, operation information sent by the LMF is received; in response to the operation information indicating the information indicating the terminal to update the parameter of the model, the terminal updates the parameter of the model.

It should be noted that those skilled in the art can understand that the methods provided in the embodiments of the present disclosure may be performed individually or may be performed together with some methods in the embodiments of the present disclosure or some methods in related art.

As shown in FIG. 15, an embodiment provides a method for monitoring an Artificial Intelligence (AI) or Machine Learning (ML) model. The method is performed by a base station. The method includes:

In step 151, assistance information is obtained. The assistance information is used for performance monitoring of the AI or ML model for terminal positioning. The AI or ML model is run on the base station.

In an embodiment, request information for monitoring the model sent by an LMF is received. Assistance information is obtained. The assistance information is used for performance monitoring of the AI or ML model for terminal positioning. Illustratively, the request information indicates a monitoring period for monitoring the model. In this way, the model can be monitored based on the monitoring period.

In an embodiment, the assistance information sent by the LMF is received. The assistance information is used to indicate at least one of: historical location information of the terminal and an uplink positioning measurement result for determining the historical location information of the terminal; or, an uplink positioning result of a PRU; the assistance information is used for performance monitoring of the AI or ML model for terminal positioning.

In an embodiment, request information for requesting the assistance information is sent to the LMF. The assistance information sent by the LMF is received. The assistance information is used to indicate at least one of: historical location information of the terminal and an uplink positioning measurement result for determining the historical location information of the terminal; or, an uplink positioning result of a PRU; the assistance information is used for performance monitoring of the AI or ML model for terminal positioning. The request information includes the requested specific assistance information, such as requesting an uplink positioning measurement result. The request information may indicate an uplink positioning reference signal. In this way, a positioning measurement may be performed based on the uplink positioning reference signal.

In an embodiment, assistance information is obtained. The assistance information is used for performance monitoring of the AI or ML model for terminal positioning. Model performance monitoring information is sent to an LMF. The performance monitoring information indicates at least one of:
model performance not meeting a requirement;
the model performance meeting the requirement;
poor model performance;
a prediction result of the model being inconsistent with reality; and
poor positioning accuracy of the model.

Model information of supported model(s) may refer to that: there may be information of multiple AI or ML models for positioning, and the terminal may support a part of the AI or ML models, or support all of the AI or ML models, and thus the terminal needs to indicate specific AI or ML model(s) that can be monitored. In addition, functions of different AI or ML models may also be different. For example, some AI or ML models can predict terminal location(s), while some AI or ML models can only predict positioning measurement result(s). Therefore, the terminal also needs to indicate that it supports monitoring of AI or ML model(s) that can predict terminal location(s), or supports monitoring of AI or ML model(s) that can predict positioning measurement result(s).

In an embodiment, assistance information is obtained. The assistance information is used for performance monitoring of an AI or ML model for terminal positioning. Operation information sent by an LMF is received. The operation information indicates at least one of:
information indicating the base station to stop using the model;
information indicating the base station to use another model; and
information indicating the base station to update a parameter of the model.

In an embodiment, operation information sent by the LMF is received; in response to the operation information indicating the information indicating the base station to stop using the model, the base station stops using the model.

In an embodiment, operation information sent by the LMF is received; in response to the operation information indicating the information indicating the base station to use another model, the base station replaces the currently used model with another model.

In an embodiment, operation information sent by the LMF is received; in response to the operation information indicating the information indicating the base station to update the parameter of the model, the base station updates the parameter of the model.

It should be noted that those skilled in the art can understand that the methods provided in the embodiments of the present disclosure may be performed individually or may be performed together with some methods in the embodiments of the present disclosure or some methods in related art.

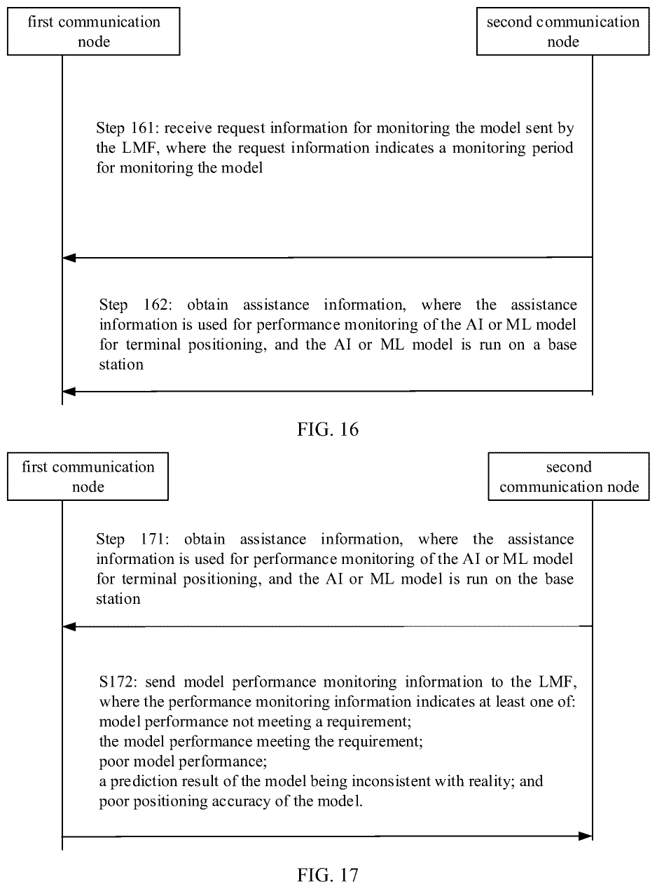

As shown in FIG. 16, an embodiment provides a method for monitoring an Artificial Intelligence (AI) or Machine Learning (ML) model. The method is performed by a base station. The method includes:

In step 161, request information for monitoring the model sent by an LMF is received. The request information indicates a monitoring period for monitoring the model.

Optionally, the method further includes step 162: obtaining assistance information. The assistance information is used for performance monitoring of the AI or ML model for terminal positioning. The AI or ML model is run on the base station.

It should be noted that those skilled in the art can understand that the methods provided in the embodiments of the present disclosure may be performed individually or may be performed together with some methods in the embodiments of the present disclosure or some methods in related art.

As shown in FIG. 17, an embodiment provides a method for monitoring an Artificial Intelligence (AI) or Machine Learning (ML) model. The method is performed by a base station. The method includes:

In step 171, assistance information is obtained. The assistance information is used for performance monitoring of the AI or ML model for terminal positioning. The AI or ML model is run on the base station. It should be noted that in the embodiment of the present disclosure, step 171 may be optional, and the embodiment of the present disclosure may only include step 172.

In step 172, model performance monitoring information is sent to an LMF. The performance monitoring information indicates at least one of:
model performance not meeting a requirement;
the model performance meeting the requirement;
poor model performance;
a prediction result of the model being inconsistent with reality; and
poor positioning accuracy of the model.

Model information of supported model(s) may refer to that: there may be information of multiple AI or ML models for positioning, and the terminal may support a part of the AI or ML models, or support all of the AI or ML models, and thus the terminal needs to indicate specific AI or ML model(s) that can be monitored. In addition, functions of different AI or ML models may also be different. For example, some AI or ML models can predict terminal location(s), while some AI or ML models can only predict positioning measurement result(s). Therefore, the terminal also needs to indicate that it supports monitoring of AI or ML model(s) that can predict terminal location(s), or supports monitoring of AI or ML model(s) that can predict positioning measurement result(s). It should be noted that those skilled in the art can understand that the methods provided in the embodiments of the present disclosure may be performed individually or may be performed together with some methods in the embodiments of the present disclosure or some methods in related art.

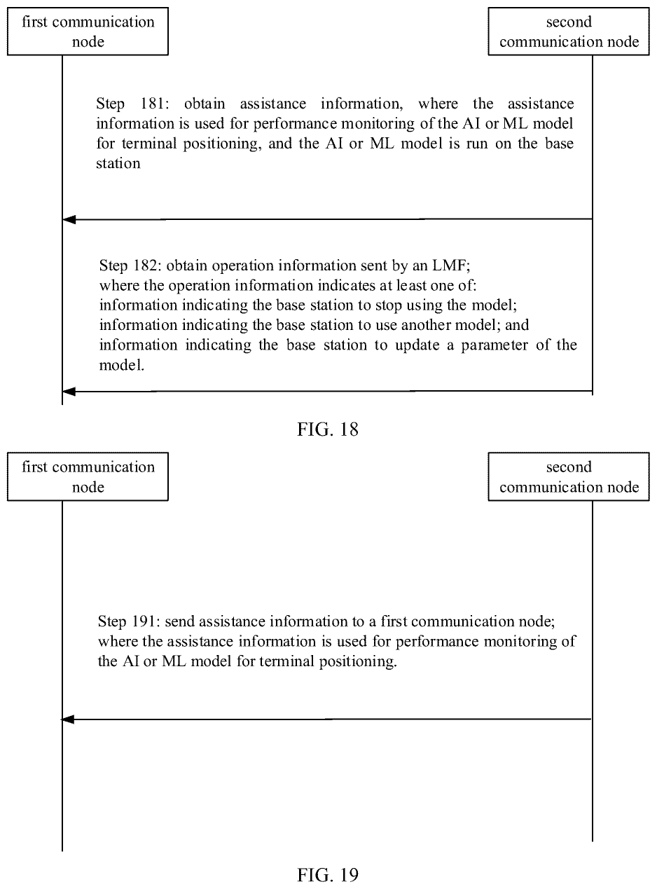

As shown in FIG. 18, an embodiment provides a method for monitoring an Artificial Intelligence (AI) or Machine Learning (ML) model. The method is performed by a base station. The method includes:

In step 181, assistance information is obtained. The assistance information is used for performance monitoring of the AI or ML model for terminal positioning. The AI or ML model is run on the base station. It should be noted that in the embodiment of the present disclosure, step 181 may be optional, and the embodiment of the present disclosure may only include step 182.

In step 182, operation information sent by an LMF is obtained.

The operation information indicates at least one of:
information indicating the base station to stop using the model;
information indicating the base station to use another model; and
information indicating the base station to update a parameter of the model.

In an embodiment, operation information sent by the LMF is received; in response to the operation information indicating the information indicating the base station to stop using the model, the base station stops using the model.

In an embodiment, operation information sent by the LMF is received; in response to the operation information indicating the information indicating the base station to use another model, the base station replaces the current model with another model.

In an embodiment, operation information sent by the LMF is received; in response to the operation information indicating the information indicating the base station to update the parameter of the model, the base station updates the parameter of the model.

It should be noted that those skilled in the art can understand that the methods provided in the embodiments of the present disclosure may be performed individually or may be performed together with some methods in the embodiments of the present disclosure or some methods in related art.

As shown in FIG. 19, an embodiment provides a method for monitoring an Artificial Intelligence (AI) or Machine Learning (ML) model. The method is performed by a second communication node. The method includes:

In step 191, assistance information is sent to a first communication node.

The assistance information is used for performance monitoring of an AI or ML model for terminal positioning.

Here, the terminal involved in the present disclosure may be, but is not limited to, a mobile phone, a wearable device, a vehicle-mounted terminal, a Road Side Unit (RSU), a smart home terminal, an industrial sensor device and/or a medical device, etc. In some embodiments, the terminal may be a Redcap terminal or a new air interface NR terminal of a predetermined version (for example, an R17 NR terminal).

The base station involved in the present disclosure may be various types of base stations, for example, a base station in a 3rd generation mobile communication (3G) network, a base station in a 4th generation mobile communication (4G) network, a base station in a 5th generation mobile communication (5G) network, or other evolved base station(s).

An LMF is involved in the present disclosure. Of course, the LMF may also be replaced by other evolved network function(s) having function(s) of the LMF, which is not limited here.

In one implementation, the second communication node sends the assistance information to the first communication node. The assistance information is used for performance monitoring of the AI or ML model for terminal positioning. The first communication node performs monitoring of the AI or ML model based on the assistance information to obtain a monitoring result. It should be noted that the monitoring of the AI or ML model may be comparing a measurement result determined based on the assistance information with a prediction result obtained by the AI or ML model. The monitoring result may be the positioning accuracy of the AI or ML model.

It should be noted that those skilled in the art can understand that the methods provided in the embodiments of the present disclosure may be performed individually or may be performed together with some methods in the embodiments of the present disclosure or some methods in related art.

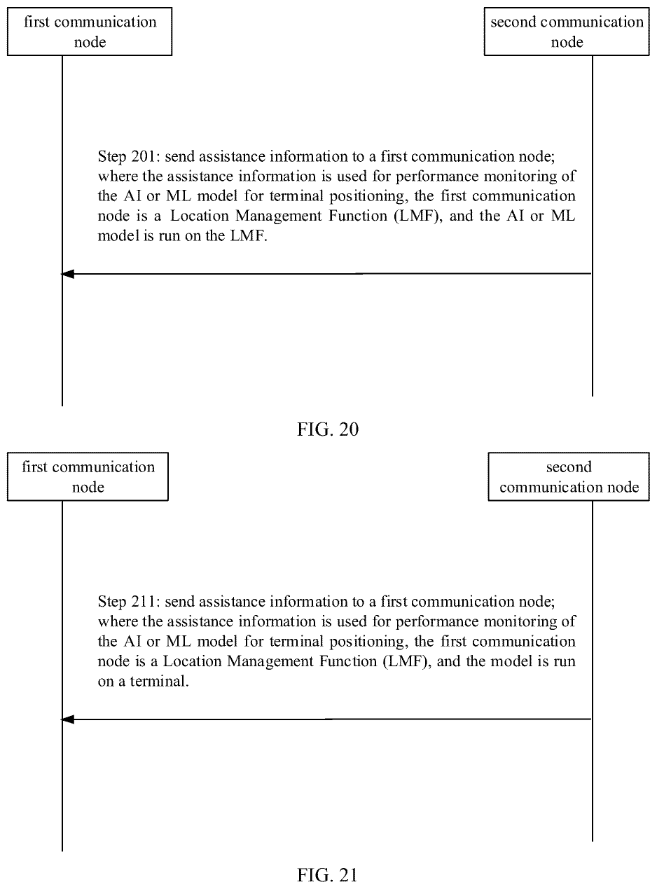

As shown in FIG. 20, an embodiment provides a method for monitoring an Artificial Intelligence (AI) or Machine Learning (ML) model. The method is performed by a second communication node. The method includes:

In step 201, assistance information is sent to a first communication node.

The assistance information is used for performance monitoring of an AI or ML model for terminal positioning. The first communication node is a Location Management Function (LMF). The AI or ML model is run on the LMF.

In an embodiment, the assistance information is sent to the LMF. The assistance information includes: a measurement result determined by an uplink positioning reference signal, or a measurement result of an uplink positioning reference signal of a terminal. The assistance information is used for performance monitoring of the AI or ML model for terminal positioning. The second communication node is a base station. Optionally, the uplink positioning reference signal may be specified by the LMF, or the terminal may be specified by the LMF.

In an embodiment, the measurement result determined based on the uplink positioning reference signal may include at least one of the following result(s): Reference Signal Receiving Power (RSRP), Reference Signal Received Path Power (RSRPP), Channel Impulse Response (CIR), Arrival of Angle (AOA), Angle of Departure (AOD) and Signal to Interference plus Noise Ratio (SINR).

In an embodiment, request information for requesting the assistance information sent by the LMF is received. The assistance information is sent to the LMF. The assistance information includes: a measurement result determined by an uplink positioning reference signal, or a measurement result of an uplink positioning reference signal of a terminal. The assistance information is used for performance monitoring of an AI or ML model for terminal positioning. The second communication node is a base station. The request information may include the requested specific assistance information, such as requesting a measurement result determined by an uplink positioning reference signal. The request information may include at least one of the following result(s): RSRP, RSRPP, CIR, AOA, AOD and SINR. Optionally, the request information may also include a specified uplink positioning reference signal or a specified UE. After the base station receives the request information, the base station measures the specified UE or the specified uplink positioning reference signal.

In an embodiment, the assistance information is sent to an LMF. The assistance information including: a measurement result determined by a downlink positioning reference signal. The assistance information is used for performance monitoring of an AI or ML model for terminal positioning. The second communication node is a terminal. Optionally, the downlink positioning reference signal may be specified by the LMF.

In an embodiment, the measurement result determined based on the downlink positioning reference signal includes at least one of the following result(s): RSRP, RSRPP, CIR, SINR, Reference Signal Time Difference (RSTD) and Time of Arrival (TOA).

In an embodiment, request information for requesting the assistance information sent by the LMF is received. The assistance information is sent to the LMF. The assistance information includes: a measurement result determined by a specified a downlink positioning reference signal. The assistance information is used for performance monitoring of an AI or ML model for terminal positioning. The second communication node is a terminal. The request information may include the requested specific assistance information, such as requesting a measurement result determined by a downlink positioning reference signal. The request information may include at least one of the following result(s): RSRP, RSRPP, CIR, SINR, RSTD and TOA. Optionally, the request information may also include a specified downlink positioning reference signal or a specified UE. After the terminal receives the request information, the terminal measures the specified UE or the specified downlink positioning reference signal.

In an embodiment, the assistance information is sent to the LMF. The assistance information includes: location information of a PRU and a measurement result determined based on a positioning reference signal. The assistance information is used for performance monitoring of an AI or ML model for terminal positioning. The second communication node is the PRU. Optionally, the positioning reference signal may be specified by the LMF.

In an embodiment, the measurement result determined based on the positioning reference signal includes at least one of the following result(s): RSRP, RSRPP, CIR, SINR, RSTD and TOA.

In an embodiment, request information for requesting the assistance information sent by the LMF is received. The assistance information is sent to the LMF. The assistance information includes: the location information of the PRU and the measurement result determined based on the positioning reference signal. The assistance information is used for performance monitoring of the AI or ML model for terminal positioning. The second communication node is the PRU. The request information may include the requested specific assistance information. Optionally, the request information may also include a specified positioning reference signal. After the PRU receives the request information, the PRU measures the specified positioning reference signal.

In an embodiment, the assistance information is sent to the LMF. The assistance information is used to indicate: information that the location of the terminal meets an expectation or information that the location of the terminal does not meet the expectation. The assistance information is used for performance monitoring of the AI or ML model for terminal positioning. The second communication node is an NWDAF.

In an embodiment, request information for requesting the assistance information sent by the LMF is received. The assistance information is sent to the LMF. The assistance information is used to indicate: information that the location of the terminal meets the expectation or information that the location of the terminal does not meet the expectation. The assistance information is used for performance monitoring of the AI or ML model for terminal positioning. The second communication node is the NWDAF. The request information may include the requested specific assistance information. Optionally, the request information may indicate the content of the information that needs to be requested, for example, information that the location of the terminal meets the expectation or information that the location of the terminal does not meet the expectation.

It should be noted that those skilled in the art can understand that the methods provided in the embodiments of the present disclosure may be performed individually or may be performed together with some methods in the embodiments of the present disclosure or some methods in related art.

As shown in FIG. 21, an embodiment provides a method for monitoring an Artificial Intelligence (AI) or Machine Learning (ML) model. The method is performed by a second communication node. The method includes:

In step 211, assistance information is sent to a first communication node.

The assistance information is used for performance monitoring of an AI or ML model for terminal positioning. The first communication node is a Location Management Function (LMF). The model is run on a terminal.

In an embodiment, the assistance information is sent to the LMF. The assistance information includes: a terminal location result predicted by the AI or ML model and a terminal location result determined by another positioning method that does not use a model; or, a positioning signal measurement result predicted by the AI or ML model and a positioning reference signal measurement result obtained by the terminal by performing an actual positioning reference signal measurement. The assistance information is used for performance monitoring of the AI or ML model for terminal positioning. The AI or ML model is run on the terminal. The second communication node is the terminal. Optionally, the positioning reference signal may be specified by the LMF, or the terminal is specified by the LMF.

In an embodiment, the other positioning method(s) mentioned above may be positioning method(s) that is(are) not based on an AI or ML model, such as Global Navigation Satellite System (GNSS), Downlink Time Difference Of Arrival (DL-TDOA), or DL-AOD, etc.

In an embodiment, the positioning reference signal measurement result obtained by the terminal by performing the actual positioning reference signal measurement may be a Reference Signal Time Difference (RSTD) or TOA, etc.

In an embodiment, request information for requesting the assistance information sent by the LMF is received. The assistance information is sent to the LMF. The assistance information includes: the terminal location result predicted by the AI or ML model and the terminal location result determined by other positioning method(s) other than the model; or, the positioning signal measurement result predicted by the AI or ML model and the positioning reference signal measurement result obtained by the terminal by performing the actual positioning reference signal measurement. The assistance information is used for performance monitoring of the AI or ML model for terminal positioning. The AI or ML model is run on the terminal. The second communication node is the terminal. The request information may include the requested specific assistance information, such as requesting the measurement result determined by the positioning reference signal, which may include at least one of the following result(s): RSTD and TOA. Optionally, the request information may also include a specified positioning reference signal, or a specified UE. After the terminal receives the request information, the terminal measures the specified UE or the specified positioning reference signal.

In an embodiment, the assistance information is sent to the LMF. The assistance information including: location information of a PRU and a measurement result obtained by measuring a positioning reference signal. The assistance information is used for performance monitoring of the AI or ML model for terminal positioning. The second communication node is the PRU. Optionally, the positioning reference signal may be specified by the LMF, or the terminal may be specified by the LMF.

In an embodiment, the measurement result obtained by measuring the positioning reference signal includes at least one of: RSPP, RSRPP, CIR, RSTD and TOA.

In an embodiment, request information for requesting the assistance information sent by the LMF is received. The assistance information is sent to the LMF. The assistance information includes: the location information of the PRU and the measurement result obtained by measuring the positioning reference signal. The assistance information is used for performance monitoring of the AI or ML model for terminal positioning. The second communication node is the PRU. The request information may include the requested specific assistance information, such as requesting the measurement result determined by the positioning reference signal, which may include at least one of the following result(s): RSPP, RSRPP, CIR, RSTD and TOA. Optionally, the request information may also include a specified positioning reference signal. After the terminal receives the request information, the terminal measures the specified positioning reference signal.

In an embodiment, the assistance information is sent to the LMF. The assistance information is used to indicate: information that a location of a terminal meets an expectation or information that the location of the terminal does not meet the expectation. The assistance information is used for performance monitoring of the AI or ML model for terminal positioning. The second communication node is a NWDAF.

In an embodiment, request information for requesting the assistance information sent by the LMF is received. The assistance information is sent to the LMF, and the assistance information is used to indicate: information that a location of a terminal meets an expectation or information that the location of the terminal does not meet the expectation. The assistance information is used for performance monitoring of the AI or ML model for terminal positioning. The second communication node is a NWDAF. The request information includes the requested specific assistance information. Optionally, the request information may indicate the content of the information that needs to be obtained, for example, information that the location of the terminal meets the expectation or information that the location of the terminal does not meet the expectation.

In an embodiment, assistance information is sent to a first communication node. The assistance information is used for performance monitoring of the AI or ML model for terminal positioning. The AI or ML model is run on a terminal. Model performance monitoring information sent by an LMF is received. The second communication node is the terminal. The performance monitoring information indicates at least one of:
model performance not meeting a requirement;
the model performance meeting the requirement;
poor model performance;
a prediction result of the model being inconsistent with reality; and
poor positioning accuracy of the model.

Optionally, the model performance not meeting the requirement may refer to that: the location of a UE or a positioning measurement result obtained by the AI or ML model does not meet a requirement for UE positioning. The poor model performance may refer to that: the positioning accuracy of the UE location obtained by the AI or ML model is low. The prediction result of the model being inconsistent with reality may refer to that: there is a large error between the location of a UE or a positioning measurement result obtained by the AI or ML mode and an actual location of the UE or an actual positioning result. The poor positioning accuracy of the model may refer to that: the positioning accuracy of the UE location obtained by the AI or ML model is low.

In an embodiment, assistance information is sent to a first communication node. The assistance information is used for performance monitoring of an AI or ML model for terminal positioning. The AI or ML model is run on the terminal. Operation information sent by an LMF is received. The second communication node is a terminal.

The operation information indicates at least one of:
information indicating the terminal to stop using the model;
information indicating the terminal to use another model; and
information indicating the terminal to update a parameter of the model.

In an embodiment, operation information sent by the LMF is received; in response to the operation information indicating the information indicating the terminal to stop using the model, the terminal stops using the model.

In an embodiment, operation information sent by the LMF is received; in response to the operation information indicating the information indicating the terminal to use another model, the terminal replaces the current model with another model.

In an embodiment, operation information sent by the LMF is received; in response to the operation information indicating the information indicating the terminal to update the parameter of the model, the terminal updates the parameter of the model.

It should be noted that those skilled in the art can understand that the methods provided in the embodiments of the present disclosure may be performed individually or may be performed together with some methods in the embodiments of the present disclosure or some methods in related art.

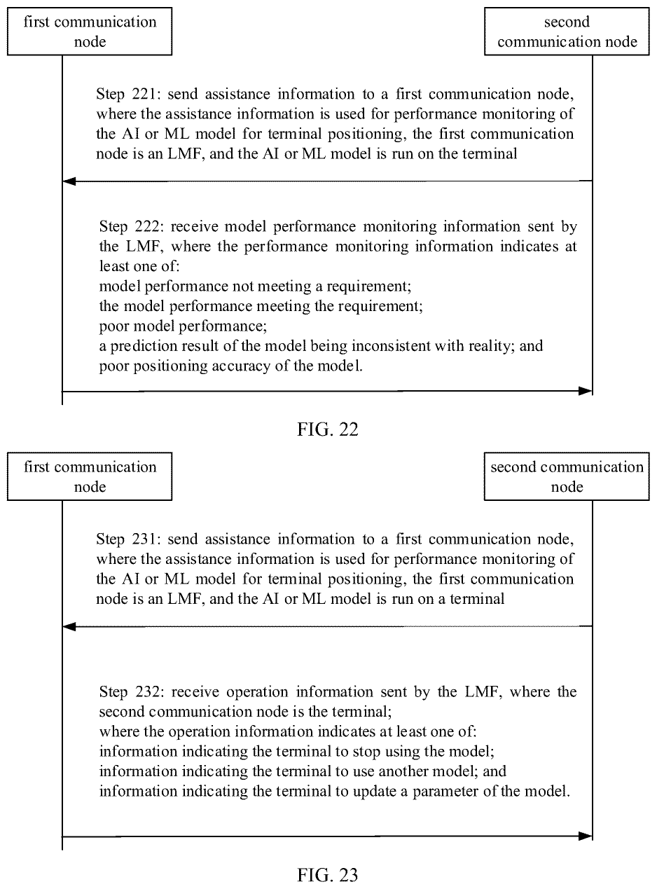

As shown in FIG. 22, an embodiment provides a method for monitoring an Artificial Intelligence (AI) or Machine Learning (ML) model. The method is performed by a second communication node. The method includes:

In step 221, assistance information is sent to a first communication node. The assistance information is used for performance monitoring of an AI or ML model for terminal positioning. The first communication node is an LMF. The AI or ML model is run on a terminal. It should be noted that in the embodiment of the present disclosure, step 221 may be optional, and the embodiment of the present disclosure may only include step 222.

In step 222, model performance monitoring information sent by the LMF is received. The second communication node is the terminal. The performance monitoring information indicates at least one of:
model performance not meeting a requirement;
the model performance meeting the requirement;
poor model performance;
a prediction result of the model being inconsistent with reality; and
poor positioning accuracy of the model.

Model information of supported model(s) may refer to that: there may be information of multiple AI or ML models for positioning, and the terminal may support a part of the AI or ML models, or support all of the AI or ML models, and thus the terminal needs to indicate specific AI or ML model(s) that can be monitored. In addition, functions of different AI or ML models may also be different. For example, some AI or ML models can predict terminal location(s), while some AI or ML models can only predict positioning measurement result(s). Therefore, the terminal also needs to indicate that it supports monitoring of AI or ML model(s) that can predict terminal location(s), or supports monitoring of AI or ML model(s) that can predict positioning measurement result(s).

It should be noted that those skilled in the art can understand that the methods provided in the embodiments of the present disclosure may be performed individually or may be performed together with some methods in the embodiments of the present disclosure or some methods in related art.

As shown in FIG. 23, an embodiment provides a method for monitoring an Artificial Intelligence (AI) or Machine Learning (ML) model. The method is performed by a second communication node. The method includes:

In step 231, assistance information is sent to a first communication node. The assistance information is used for performance monitoring of an AI or ML model for terminal positioning. The first communication node is an LMF. The AI or ML model is run on a terminal. It should be noted that in the embodiment of the present disclosure, step 231 may be optional, and the embodiment of the present disclosure may only include step 232.

In step 232, operation information sent by the LMF is received. The second communication node is the terminal.

The operation information indicates at least one of:
information indicating the terminal to stop using the model;
information indicating the terminal to use another model; and
information indicating the terminal to update a parameter of the model.

In an embodiment, operation information sent by the LMF is received; in response to the operation information indicating the information indicating the terminal to stop using the model, the terminal stops using the model.

In an embodiment, operation information sent by the LMF is received; in response to the operation information indicating the information indicating the terminal to use another model, the terminal replaces the current model with another model.

In an embodiment, operation information sent by the LMF is received; in response to the operation information indicating the information indicating the terminal to update the parameter of the model, the terminal updates the parameter of the model.

It should be noted that those skilled in the art can understand that the methods provided in the embodiments of the present disclosure may be performed individually or may be performed together with some methods in the embodiments of the present disclosure or some methods in related art.

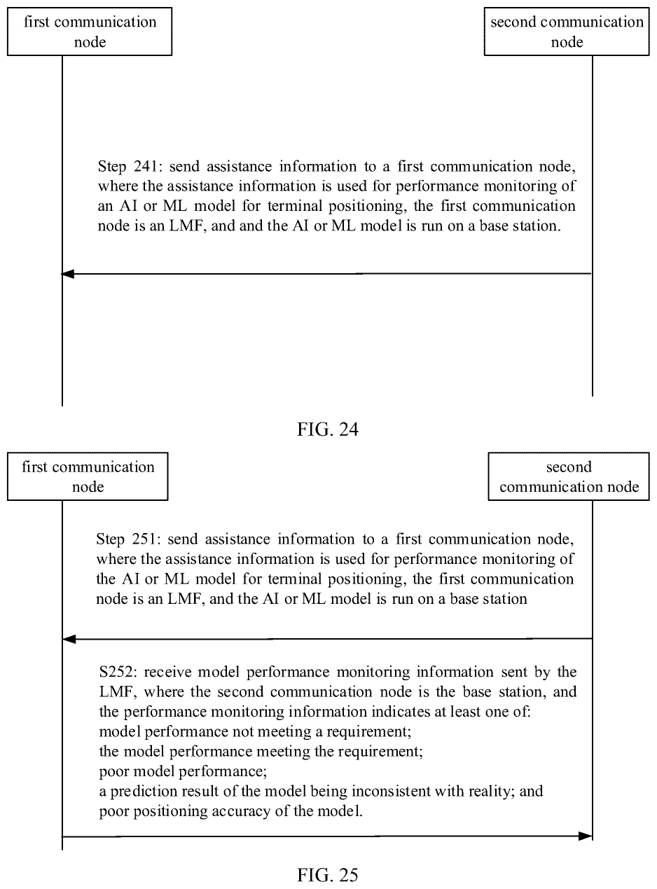

As shown in FIG. 24, an embodiment provides a method for monitoring an Artificial Intelligence (AI) or Machine Learning (ML) model. The method is performed by a second communication node. The method includes:

In step 241, assistance information is sent to a first communication node. The assistance information is used for performance monitoring of an AI or ML model for terminal positioning. The first communication node is an LMF. The AI or ML model is run on a base station.

In an embodiment, the assistance information is sent to the LMF. The assistance information includes: a positioning reference signal measurement result predicted by the AI or ML model and a positioning reference signal measurement result obtained by the base station by performing an actual positioning reference signal measurement. The assistance information is used for performance monitoring of the AI or ML model for terminal positioning. The second communication node is the base station. Optionally, the positioning reference signal may be specified by the LMF.

In an embodiment, request information for requesting the assistance information sent by the LMF is received. The assistance information is sent to LMF. The assistance information includes: the positioning reference signal measurement result predicted by the AI or ML model and the positioning reference signal measurement result obtained by the base station by performing the actual positioning reference signal measurement. The assistance information is used for performance monitoring of the AI or ML model for terminal positioning. The second communication node is the base station. The request information may include the requested specific assistance information, such as requesting the measurement result determined by the positioning reference signal, which may include at least one of the following result(s): AOA, AOD and flight time. Optionally, the request information may also include a specified positioning reference signal, or a specified UE. After thee terminal receives the request information, the terminal measures the specified UE or the specified positioning reference signal.

In an embodiment, the assistance information is sent to the LMF. The assistance information is used to indicate: location information of a PRU and a measurement result obtained by measuring the positioning reference signal. The assistance information is used for performance monitoring of the AI or ML model for the terminal positioning. The second communication node is the PRU. Optionally, the positioning reference signal may be specified by the LMF.

In an embodiment, request information for requesting the assistance information sent by the LMF is received. The assistance information is sent to the LMF. The assistance information is used to indicate: the location information of the PRU and the measurement result obtained by measuring the positioning reference signal. The assistance information is used for performance monitoring of the AI or ML model for terminal positioning. The second communication node is the PRU. The request information may include the requested specific assistance information, such as requesting the measurement result obtained by the positioning reference signal. Optionally, the request information may also include a specified positioning reference signal. After the PRU receives the request information, the PRU measures the specified positioning reference signal.

In an embodiment, assistance information is sent to a first communication node. The assistance information is used for performance monitoring of an AI or ML model for terminal positioning. The AI or ML model is run on a base station. Model performance monitoring information sent by an LMF is received. The second communication node is the base station. The performance monitoring information indicates at least one of:
model performance not meeting a requirement;
the model performance meeting the requirement;
poor model performance;
a prediction result of the model being inconsistent with reality; and
poor positioning accuracy of the model.

Model information of supported model(s) may refer to that: there may be information of multiple AI or ML models for positioning, and the terminal may support a part of the AI or ML models, or support all of the AI or ML models, and thus the terminal needs to indicate specific AI or ML model(s) that can be monitored. In addition, functions of different AI or ML models may also be different. For example, some AI or ML models can predict terminal location(s), while some AI or ML models can only predict positioning measurement result(s). Therefore, the terminal also needs to indicate that it supports monitoring of AI or ML model(s) that can predict terminal location(s), or supports monitoring of AI or ML model(s) that can predict positioning measurement result(s).

In an embodiment, assistance information is sent to a first communication node. The assistance information is used for performance monitoring of an AI or ML model for terminal positioning. The AI or ML model is run on a base station. Operation information sent by an LMF is received. The second communication node is the base station. The operation information indicates at least one of:
information indicating the base station to stop using the model;
information indicating the base station to use another model; and
information indicating the base station to update a parameter of the model.

In an embodiment, operation information sent by the LMF is received; in response to the operation information indicating information indicating the base station to stop using the model, the base station stops using the model.

In an embodiment, operation information sent by the LMF is received; in response to the operation information indicating the information indicating the base station to use another model, the base station replaces the current model with another model.

In an embodiment, operation information sent by the LMF is received; in response to the operation information indicating the information indicating the base station to update the parameter of the model, the base station updates the parameter of the model.

It should be noted that those skilled in the art can understand that the methods provided in the embodiments of the present disclosure may be performed individually or may be performed together with some methods in the embodiments of the present disclosure or some methods in related art.

As shown in FIG. 25, an embodiment provides a method for monitoring an Artificial Intelligence (AI) or Machine Learning (ML) model. The method is performed by a second communication node. The method includes:

In step 251, assistance information is sent to a first communication node. The assistance information is used for performance monitoring of an AI or ML model for terminal positioning. The first communication node is an LMF. The AI or ML model is run on a base station. It should be noted that in the embodiment of the present disclosure, step 251 may be optional, and the embodiment of the present disclosure may only include step 252.

In step 252, model performance monitoring information sent by the LMF is received. The second communication node is the base station. The performance monitoring information indicates at least one of:
model performance not meeting a requirement;
the model performance meeting the requirement;
poor model performance;
a prediction result of the model being inconsistent with reality; and
poor positioning accuracy of the model.

Model information of supported model(s) may refer to that: there may be information of multiple AI or ML models for positioning, and the terminal may support a part of the AI or ML models, or support all of the AI or ML models, and thus the terminal needs to indicate specific AI or ML model(s) that can be monitored. In addition, functions of different AI or ML models may also be different. For example, some AI or ML models can predict terminal location(s), while some AI or ML models can only predict positioning measurement result(s). Therefore, the terminal also needs to indicate that it supports monitoring of AI or ML model(s) that can predict terminal location(s), or supports monitoring of AI or ML model(s) that can predict positioning measurement result(s).

It should be noted that those skilled in the art can understand that the methods provided in the embodiments of the present disclosure may be performed individually or may be performed together with some methods in the embodiments of the present disclosure or some methods in related art.

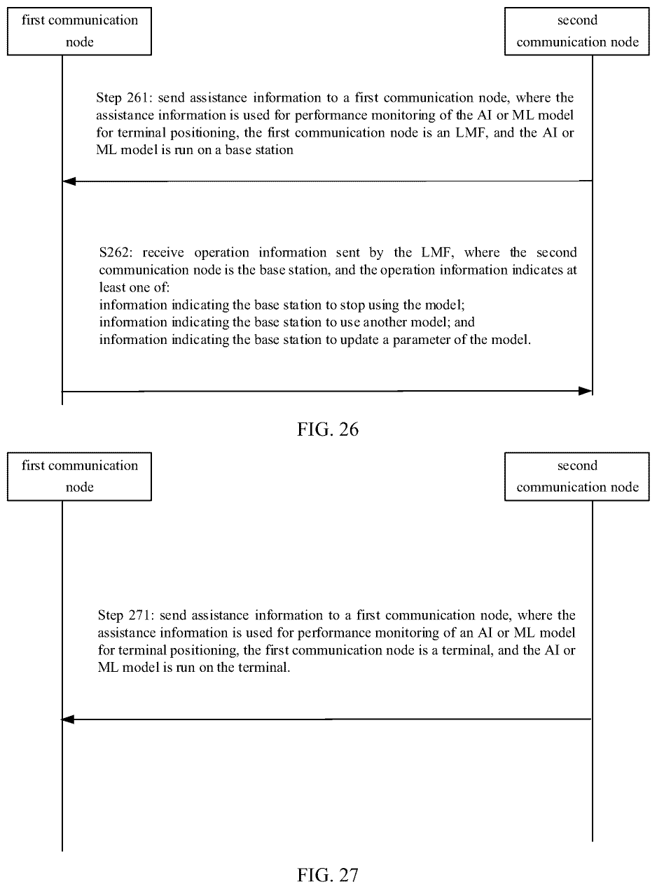

As shown in FIG. 26, an embodiment provides a method for monitoring an Artificial Intelligence (AI) or Machine Learning (ML) model. The method is performed by a second communication node. The method includes:

In step 261, assistance information is sent to a first communication node. The assistance information is used for performance monitoring of an AI or ML model for terminal positioning. The first communication node is an LMF. The AI or ML model is run on a base station. It should be noted that in the embodiment of the present disclosure, step 261 may be optional, and the embodiment of the present disclosure may only include step 262.

In step 262, operation information sent by the LMF is received. The second communication node is the base station. The operation information indicates at least one of:
information indicating the base station to stop using the model;
information indicating the base station to use another model; and
information indicating the base station to update a parameter of the model.

In an embodiment, operation information sent by the LMF is received; in response to the operation information indicating the information indicating the base station to stop using the model, the base station stops using the model.

In an embodiment, operation information sent by the LMF is received; in response to the operation information indicating the information indicating the base station to use another model, the base station replaces the current model with another model.

In an embodiment, operation information sent by the LMF is received; in response to the operation information indicating the information indicating the base station to update the parameter of the model, the base station updates the parameter of the model.

It should be noted that those skilled in the art can understand that the methods provided in the embodiments of the present disclosure may be performed individually or may be performed together with some methods in the embodiments of the present disclosure or some methods in related art.

As shown in FIG. 27, an embodiment provides a method for monitoring an Artificial Intelligence (AI) or Machine Learning (ML) model. The method is performed by a second communication node. The method includes:

In step 271, assistance information is sent to a first communication node. The assistance information is used for performance monitoring of an AI or ML model for terminal positioning. The first communication node is a terminal. The AI or ML model is run on the terminal.

In an embodiment, capability information of the terminal for model performance monitoring is received from the terminal. The capability information indicates at least one of: model information of supported model(s); monitoring of positioning accuracy being supported; monitoring of positioning measurement result(s) being supported. Assistance information is sent to the terminal. The assistance information is used for performance monitoring of an AI or ML model for terminal positioning. The AI or ML model is run on the terminal. The second communication node is an LMF.

Model information of supported model(s) may refer to that: there may be information of multiple AI or ML models for positioning, and the terminal may support a part of the AI or ML models, or support all of the AI or ML models, and thus the terminal needs to indicate specific AI or ML model(s) that can be monitored. In addition, functions of different AI or ML models may also be different. For example, some AI or ML models can predict terminal location(s), while some AI or ML models can only predict positioning measurement result(s). Therefore, the terminal also needs to indicate that it supports monitoring of AI or ML model(s) that can predict terminal location(s), or supports monitoring of AI or ML model(s) that can predict positioning measurement result(s).

In an embodiment, request information is sent to the terminal. The request information is used to request the capability information. The capability information of the terminal for model performance monitoring sent by the terminal is received. The capability information indicates at least one of: model information of supported model(s); monitoring of positioning accuracy being supported; monitoring of positioning measurement result(s) being supported. Assistance information is obtained. The assistance information is used for performance monitoring of an AI or ML model for terminal positioning. The AI or ML model is run on the terminal. The second communication node is an LMF. The request information may include the requested specific assistance information, such as requesting at least one of: model information of supported model(s), monitoring of positioning accuracy being supported, and monitoring of positioning measurement result(s) being supported.

In an embodiment, the assistance information is sent to the terminal. The assistance information is used to include at least one of: a distance between the terminal and a base station and a positioning measurement result of the terminal; location information of the terminal and the positioning measurement result of the terminal; location information of a PRU and a positioning measurement result of the PRU; and historical location information of the terminal and a measurement result for determining the historical location information of the terminal. The assistance information is used for performance monitoring of an AI or ML model for terminal positioning. The AI or ML model is run on the terminal. The second communication node is an LMF.

In an embodiment, request information for requesting the assistance information sent by the terminal is received. The request information indicates at least one of: an AI or ML model that needs to be monitored; and an application scenario of the AI or ML model. The assistance information is sent to the terminal. The assistance information is used to include at least one of: a distance between the terminal and a base station and a positioning measurement result of the terminal; location information of the terminal and the positioning measurement result of the terminal; location information of a PRU and a positioning measurement result of the PRU; and historical location information of the terminal and a measurement result for determining the historical location information of the terminal. The assistance information is used for performance monitoring of an AI or ML model for terminal positioning. The AI or ML model is run on the terminal. The second communication node is an LMF. The request information may include the requested specific assistance information, such as requesting the positioning measurement result of the terminal, and may include at least one of the following result(s): RSRP, RSRPP, SINR, Signal to Noise Ratio (SNR), TOA and RSTD. Optionally, the request information may also include a specified positioning reference signal. After the terminal receives the request information, the terminal measures the specified positioning reference signal.

In an embodiment, request information for monitoring the model is sent to the terminal. The request information indicates a monitoring period for monitoring the model. Assistance information is obtained. The assistance information is used for performance monitoring of an AI or ML model for terminal positioning. The AI or ML model is run on the terminal. The second communication node is an LMF.

In an embodiment, assistance information is sent to a first communication node. The assistance information is used for performance monitoring of the AI or ML model for terminal positioning. The first communication node is the terminal. The AI or ML model is run on the terminal. Model performance monitoring information sent by the terminal is received. The second communication node is an LMF. The performance monitoring information indicates at least one of:
model performance not meeting a requirement;
the model performance meeting the requirement;
poor model performance;
a prediction result of the model being inconsistent with reality; and
poor positioning accuracy of the model.

Model information of supported model(s) may refer to that: there may be information of multiple AI or ML models for positioning, and the terminal may support a part of the AI or ML models, or support all of the AI or ML models, and thus the terminal needs to indicate specific AI or ML model(s) that can be monitored. In addition, functions of different AI or ML models may also be different. For example, some AI or ML models can predict terminal location(s), while some AI or ML models can only predict positioning measurement result(s). Therefore, the terminal also needs to indicate that it supports monitoring of AI or ML model(s) that can predict terminal location(s), or supports monitoring of AI or ML model(s) that can predict positioning measurement result(s).

In an embodiment, assistance information is sent to a first communication node. The assistance information is used for performance monitoring of an AI or ML model for terminal positioning. The first communication node is a terminal. The AI or ML model is run on the terminal. Operation information is sent to the terminal. The second communication node is an LMF. The operation information indicates at least one of:
information indicating the terminal to stop using the model;
information indicating the terminal to use another model; and
information indicating the terminal to update a parameter of the model.

In an embodiment, operation information sent by the LMF is received; in response to the operation information indicating the information indicating the terminal to stop using the model, the terminal stops using the model.

In an embodiment, operation information sent by the LMF is received; in response to the operation information indicating the information indicating the terminal to use another model, the terminal replaces the current model with another model.

In an embodiment, operation information sent by the LMF is received; in response to the operation information indicating the information indicating the terminal to update the parameter of the model, the terminal updates the parameter of the model.

It should be noted that those skilled in the art can understand that the methods provided in the embodiments of the present disclosure may be performed individually or may be performed together with some methods in the embodiments of the present disclosure or some methods in related art.

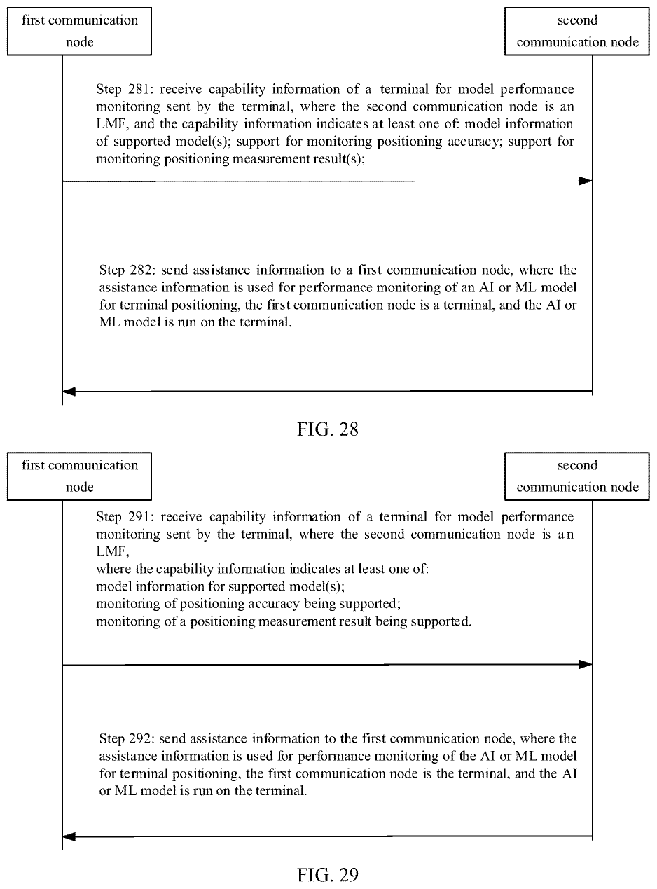

As shown in FIG. 28, an embodiment provides a method for monitoring an Artificial Intelligence (AI) or Machine Learning (ML) model. The method is performed by a second communication node. The method includes:

In step 281, capability information of a terminal for model performance monitoring sent by the terminal is received. The second communication node is an LMF. The capability information indicates at least one of: model information of supported model(s); monitoring of positioning accuracy being supported; monitoring of positioning measurement result(s) being supported.

Optionally, the method further includes step 282: sending assistance information to a first communication node. The assistance information is used for performance monitoring of an AI or ML model for terminal positioning. The first communication node is the terminal. The AI or ML model is run on the terminal.

It should be noted that those skilled in the art can understand that the methods provided in the embodiments of the present disclosure may be performed individually or may be performed together with some methods in the embodiments of the present disclosure or some methods in related art.

As shown in FIG. 29, an embodiment provides a method for monitoring an Artificial Intelligence (AI) or Machine Learning (ML) model. The method is performed by a second communication node. The method includes:

In step 291, capability information of a terminal for model performance monitoring sent by the terminal is received. The second communication node is an LMF.

The capability information indicates at least one of:
model information for supported model(s);
monitoring of positioning accuracy being supported;
monitoring of positioning measurement result(s) being supported.

Optionally, the method also includes step 292: sending assistance information to a first communication node. The assistance information is used for performance monitoring of an AI or ML model for terminal positioning. The first communication node is the terminal. The AI or ML model is run on the terminal.

In an embodiment, request information is sent to the terminal. The request information is used to request the capability information. The capability information of the terminal for model performance monitoring sent by the terminal is received. The capability information indicates at least one of: model information of supported model(s); monitoring of positioning accuracy being supported; monitoring of positioning measurement result(s) being supported. Assistance information is sent to the terminal. The assistance information is used for performance monitoring of the AI or ML model for terminal positioning. The AI or ML model is run on the terminal. The second communication node is an LMF.

It should be noted that those skilled in the art can understand that the methods provided in the embodiments of the present disclosure may be performed individually or may be performed together with some methods in the embodiments of the present disclosure or some methods in related art.

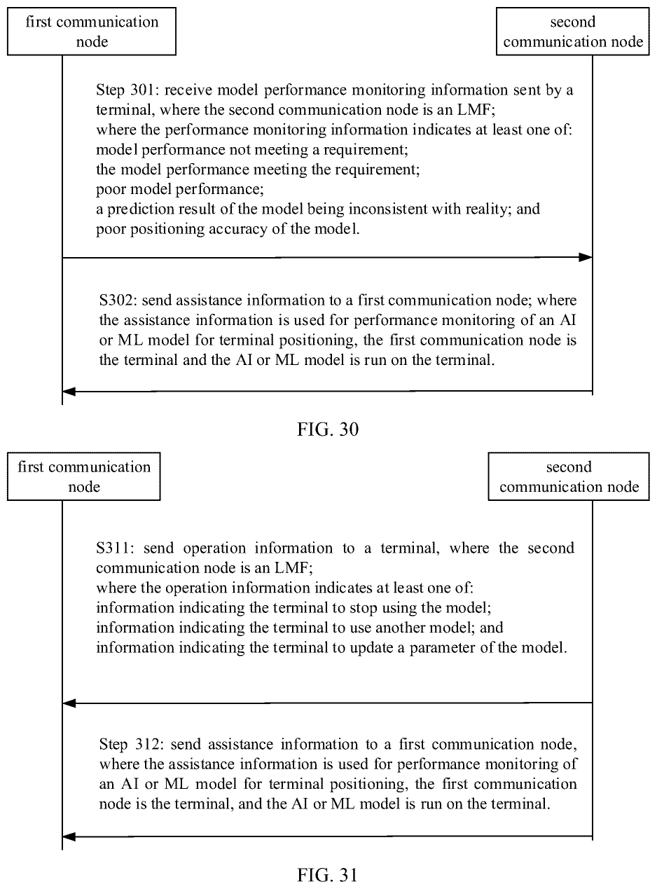

As shown in FIG. 30, an embodiment provides a method for monitoring an Artificial Intelligence (AI) or Machine Learning (ML) model. The method is performed by a second communication node. The method includes:

In step 301, model performance monitoring information sent by a terminal is received. The second communication node is an LMF.

The performance monitoring information indicates at least one of:
model performance not meeting a requirement;
the model performance meeting the requirement;
poor model performance;
a prediction result of the model being inconsistent with reality; and
poor positioning accuracy of the model.

Model information of supported model(s) may refer to that: there may be information of multiple AI or ML models for positioning, and the terminal may support a part of the AI or ML models, or support all of the AI or ML models, and thus the terminal needs to indicate specific AI or ML model(s) that can be monitored. In addition, functions of different AI or ML models may also be different. For example, some AI or ML models can predict terminal location(s), while some AI or ML models can only predict positioning measurement result(s). Therefore, the terminal also needs to indicate that it supports monitoring of AI or ML model(s) that can predict terminal location(s), or supports monitoring of AI or ML model(s) that can predict positioning measurement result(s).

Optionally, the method also includes step 302: sending assistance information to a first communication node. The assistance information is used for performance monitoring of an AI or ML model for terminal positioning. The first communication node is the terminal. The AI or ML model is run on the terminal.

It should be noted that those skilled in the art can understand that the methods provided in the embodiments of the present disclosure may be performed individually or may be performed together with some methods in the embodiments of the present disclosure or some methods in related art.

As shown in FIG. 31, an embodiment provides a method for monitoring an Artificial Intelligence (AI) or Machine Learning (ML) model. The method is performed by a second communication node. The method includes:

In step 311, operation information is sent to a terminal. The second communication node is an LMF.

The operation information indicates at least one of:
information indicating the terminal to stop using the model;
information indicating the terminal to use another model; and
information indicating the terminal to update a parameter of the model.

Optionally, the method further includes step 312: sending assistance information to a first communication node. The assistance information is used for performance monitoring of an AI or ML model for terminal positioning. The first communication node is the terminal. The AI or ML model is run on the terminal.

In an embodiment, operation information sent by the LMF is received; in response to the operation information indicating the information indicating the terminal to stop using the model, the terminal stops using the model.

In an embodiment, operation information sent by the LMF is received; in response to the operation information indicating the information indicating the terminal to use another model, the terminal replaces the current model with another model.

In an embodiment, operation information sent by the LMF is received; in response to the operation information indicating the information indicating the terminal to update the parameter of the model, the terminal updates the parameter of the model.

It should be noted that those skilled in the art can understand that the methods provided in the embodiments of the present disclosure may be performed individually or may be performed together with some methods in the embodiments of the present disclosure or some methods in related art.

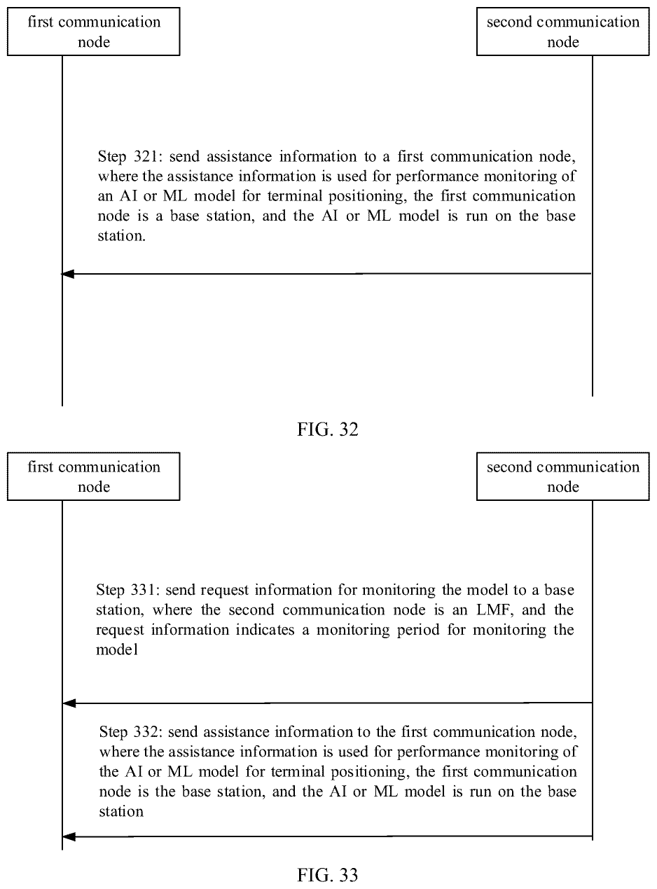

As shown in FIG. 32, an embodiment provides a method for monitoring an Artificial Intelligence (AI) or Machine Learning (ML) model. The method is performed by a second communication node. The method includes:

In step 321, assistance information is sent to a first communication node. The assistance information is used for performance monitoring of an AI or ML model for terminal positioning. The first communication node is a base station. The AI or ML model is run on the base station.

In an embodiment, request information for monitoring the model is sent to the base station. Assistance information is obtained. The assistance information is used for performance monitoring of the AI or ML model for terminal positioning. The request information indicates a monitoring period for monitoring the model. The second communication node is an LMF. In this way, the model can be monitored based on the monitoring period.

In an embodiment, the assistance information is sent to the base station. The assistance information is used to indicate at least one of: historical location information of a terminal and an uplink positioning measurement result for determining the historical location information of the terminal; or an uplink positioning result of a PRU. The assistance information is used for performance monitoring of the AI or ML model for terminal positioning. The second communication node is an LMF.

In an embodiment, request information for requesting the assistance information sent by the base station is received. The assistance information sent by the LMF is received. The assistance information is used to indicate at least one of: historical location information of a terminal and an uplink positioning measurement result for determining the historical location information of the terminal; or an uplink positioning result of a PRU. The assistance information is used for performance monitoring of the AI or ML model for terminal positioning. The second communication node is the LMF. The request information includes requested specific assistance information, such as requesting an uplink positioning measurement result. The request information may indicate an uplink positioning reference signal. In this way, a positioning measurement may be performed based on the uplink positioning reference signal.

In an embodiment, assistance information is sent to a first communication node. The first communication node is the base station. The assistance information is used for performance monitoring of an AI or ML model for terminal positioning. Model performance monitoring information sent by the base station is received. The second communication node is an LMF. The performance monitoring information indicates at least one of:
model performance not meeting a requirement;
the model performance meeting the requirement;
poor model performance;
a prediction result of the model being inconsistent with reality; and poor positioning accuracy of the model.

Model information of supported model(s) may refer to that: there may be information of multiple AI or ML models for positioning, and the terminal may support a part of the AI or ML models, or support all of the AI or ML models, and thus the terminal needs to indicate specific AI or ML model(s) that can be monitored. In addition, functions of different AI or ML models may also be different. For example, some AI or ML models can predict terminal location(s), while some AI or ML models can only predict positioning measurement result(s). Therefore, the terminal also needs to indicate that it supports monitoring of AI or ML model(s) that can predict terminal location(s), or supports monitoring of AI or ML model(s) that can predict positioning measurement result(s).

In an embodiment, assistance information is sent to a first communication node. The first communication node is the base station. The assistance information is used for performance monitoring of an AI or ML model for terminal positioning. Operation information sent by an LMF is received. The second communication node is the LMF. The operation information indicates at least one of:
information indicating the base station to stop using the model;
information indicating the base station to use another model; and
information indicating the base station to update a parameter of the model.

In an embodiment, operation information sent by the LMF is received; in response to the operation information indicating the information indicating the base station to stop using the model, the base station stops using the model.

In an embodiment, operation information sent by the LMF is received; in response to the operation information indicating the information indicating the base station to use another model, the base station replaces the currently used model with another model.

In an embodiment, operation information sent by the LMF is received; in response to the operation information indicating the information indicating the base station to update the parameter of the model, the base station updates the parameter of the model.

It should be noted that those skilled in the art can understand that the methods provided in the embodiments of the present disclosure may be performed individually or may be performed together with some methods in the embodiments of the present disclosure or some methods in related art.

As shown in FIG. 33, an embodiment provides a method for monitoring an Artificial Intelligence (AI) or Machine Learning (ML) model. The method is performed by a second communication node. The method includes:

In step 331, request information for monitoring the model is sent to a base station. The second communication node is an LMF. The request information indicates a monitoring period for monitoring the model.

Optionally, the method further includes step 332: sending assistance information to a first communication node. The assistance information is used for performance monitoring of the AI or ML model for terminal positioning. The first communication node is a base station. The AI or ML model is run on the base station.

It should be noted that those skilled in the art can understand that the methods provided in the embodiments of the present disclosure may be performed individually or may be performed together with some methods in the embodiments of the present disclosure or some methods in related art.

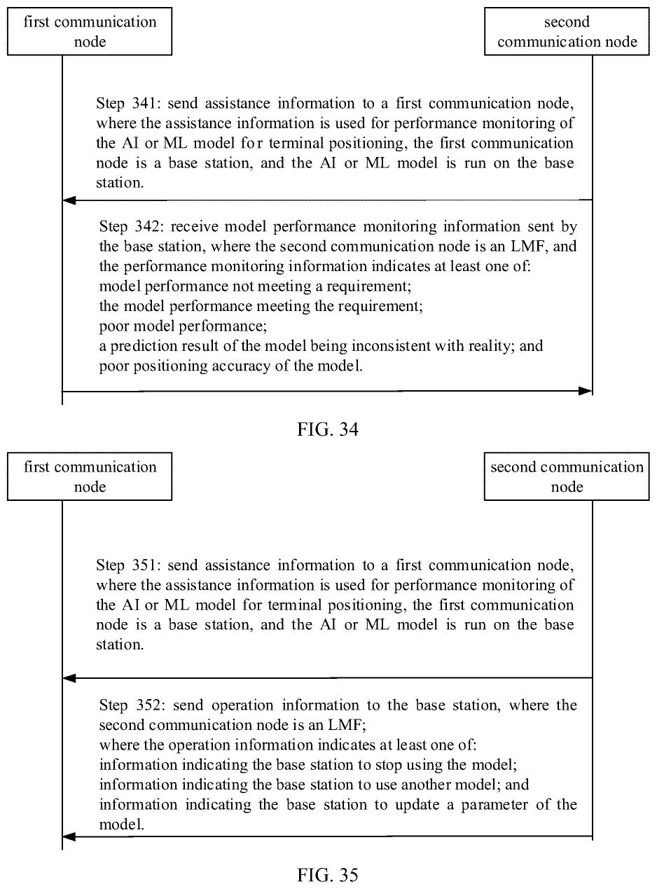

As shown in FIG. 34, an embodiment provides a method for monitoring an Artificial Intelligence (AI) or Machine Learning (ML) model. The method is performed by a second communication node. The method includes:

In step 341, assistance information is sent to a first communication node. The assistance information is used for performance monitoring of an AI or ML model for terminal positioning. The first communication node is a base station. The AI or ML model is run on the base station. It should be noted that in the embodiment of the present disclosure, step 341 may be optional, and the embodiment of the present disclosure may only include step 342.

In step 342, model performance monitoring information sent by the base station is received. The second communication node is an LMF. The performance monitoring information indicates at least one of:
model performance not meeting a requirement;
the model performance meeting the requirement;
poor model performance;
a prediction result of the model being inconsistent with reality; and
poor positioning accuracy of the model.

It should be noted that those skilled in the art can understand that the methods provided in the embodiments of the present disclosure may be performed individually or may be performed together with some methods in the embodiments of the present disclosure or some methods in related art.

As shown in FIG. 35, an embodiment provides a method for monitoring an Artificial Intelligence (AI) or Machine Learning (ML) model. The method is performed by a second communication node. The method includes:

In step 351, assistance information is sent to a first communication node. The assistance information is used for performance monitoring of an AI or ML model for terminal positioning. The first communication node is a base station. The AI or ML model is run on the base station. It should be noted that in the embodiment of the present disclosure, step 351 may be optional, and the embodiment of the present disclosure may only include step 352.

In step 352, operation information is sent to the base station. The second communication node is an LMF.

The operation information indicates at least one of:
information indicating the base station to stop using the model;
information indicating the base station to use another model; and
information indicating the base station to update a parameter of the model.

In an embodiment, operation information sent by the LMF is received; in response to the operation information indicating the information indicating the base station to stop using the model, the base station stops using the model.

In an embodiment, operation information sent by the LMF is received; in response to the operation information indicating the information indicating the base station to use another model, the base station replaces the current model with another model.

In an embodiment, operation information sent by the LMF is received; in response to the operation information indicating the information indicating the base station to update the parameter of the model, the base station updates the parameter of the model.

It should be noted that those skilled in the art can understand that the methods provided in the embodiments of the present disclosure may be performed individually or may be performed together with some methods in the embodiments of the present disclosure or some methods in related art.

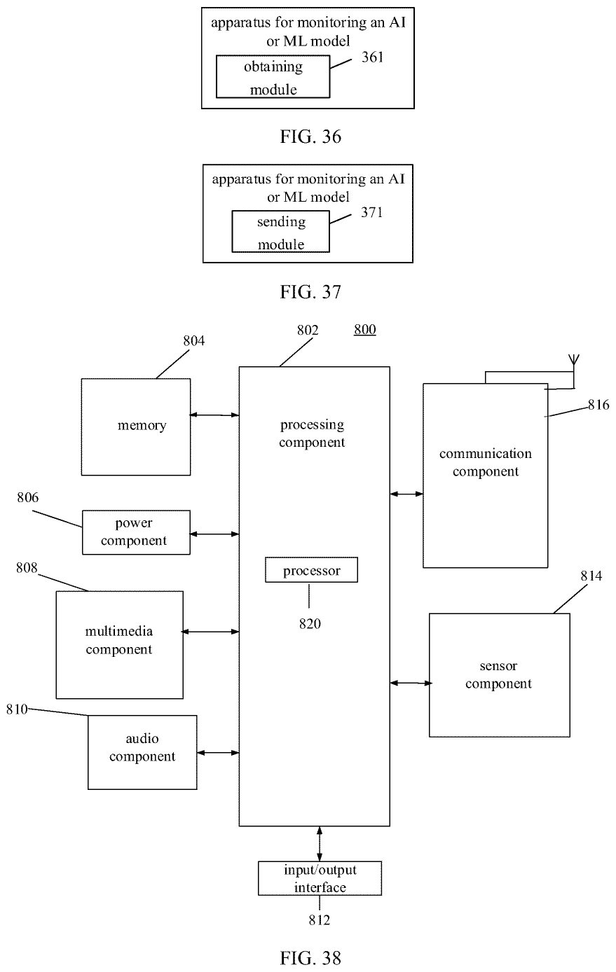

As shown in FIG. 36, an embodiment of the present disclosure provides an apparatus for monitoring an Artificial Intelligence (AI) or Machine Learning (ML) model. The apparatus includes:
an execution module 361 configured to perform performance monitoring of an AI or ML model used for terminal positioning.

It should be noted that those skilled in the art can understand that the methods provided in the embodiments of the present disclosure may be performed individually or may be performed together with some methods in the embodiments of the present disclosure or some methods in related art.

As shown in FIG. 37, an embodiment of the present disclosure provides an apparatus for monitoring an Artificial Intelligence (AI) or Machine Learning (ML) model. The apparatus includes:
a sending module 371 configured to send assistance information to a first communication node.

The assistance information is used for performance monitoring of an AI or ML model for terminal positioning.

It should be noted that those skilled in the art can understand that the methods provided in the embodiments of the present disclosure may be performed individually or may be performed together with some methods in the embodiments of the present disclosure or some methods in related art.

An embodiment of the present disclosure provides a communication device. The communication device includes:
a processor; and
a memory configured to store instructions executable by the processor;
where the processor is configured to perform the method applied to any embodiment of the present disclosure when running the executable instructions.

The memory may include various types of storage medium, which may be non-transitory computer storage medium that can continue to memorize information stored thereon after the communication device is powered off.

The processor may be connected to the memory through a bus or the like, and may be configured to read the executable program stored in the memory.

An embodiment of the present disclosure further provides a computer storage medium storing a computer executable program. When the executable program is executed by a processor, the method according to any embodiment of the present disclosure is implemented.

Regarding the apparatuses in the above embodiments, the specific manner in which each module performs the operations has been described in detail in the embodiments of the methods, and will not be elaborated here.

As shown in FIG. 38, an embodiment of the present disclosure provides a structure of a terminal.

Referring to the terminal 800 shown in FIG. 38, the embodiment provides a terminal 800. The terminal may specifically be a mobile phone, a computer, a digital broadcast terminal, a messaging device, a gaming console, a tablet, a medical device, exercise equipment, a personal digital assistant, and the like.

Referring to FIG. 38, the terminal 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the terminal 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the terminal 800. Examples of such data include instructions for any applications or methods operated on the terminal 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the terminal 800. The power component 806 may include a power management system, one or more power sources, and any other components associated with the generation, management, and distribution of power in the terminal 800.

The multimedia component 808 includes a screen providing an output interface between the terminal 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the terminal 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the terminal 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the terminal 800. For instance, the sensor component 814 may detect an open/closed status of the terminal 800, relative positioning of components, e.g., the display and the keypad, of the terminal 800, a change in position of the terminal 800 or a component of the terminal 800, a presence or absence of user contact with the terminal 800, an orientation or an acceleration/deceleration of the terminal 800, and a change in temperature of the terminal 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the terminal 800 and other devices. The terminal 800 can access a wireless network based on a communication standard, such as Wi-Fi, 2G, or 3G, or a combination thereof. In one example embodiment, the communication component 816 receives a broadcast signal or broadcast associated information from an external broadcast management system via a broadcast channel. In one example embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In example embodiments, the terminal 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In example embodiments, there is also provided a non-transitory computer-readable storage medium including instructions, such as the memory 804 including instructions executable by the processor 820 in the terminal 800, for performing the above-described methods. For example, the non-transitory computer-readable storage medium may be a ROM, a Random Access Memory (RAM), a CD-ROM, a magnetic tape, a floppy disc, an optical data storage device, and the like.

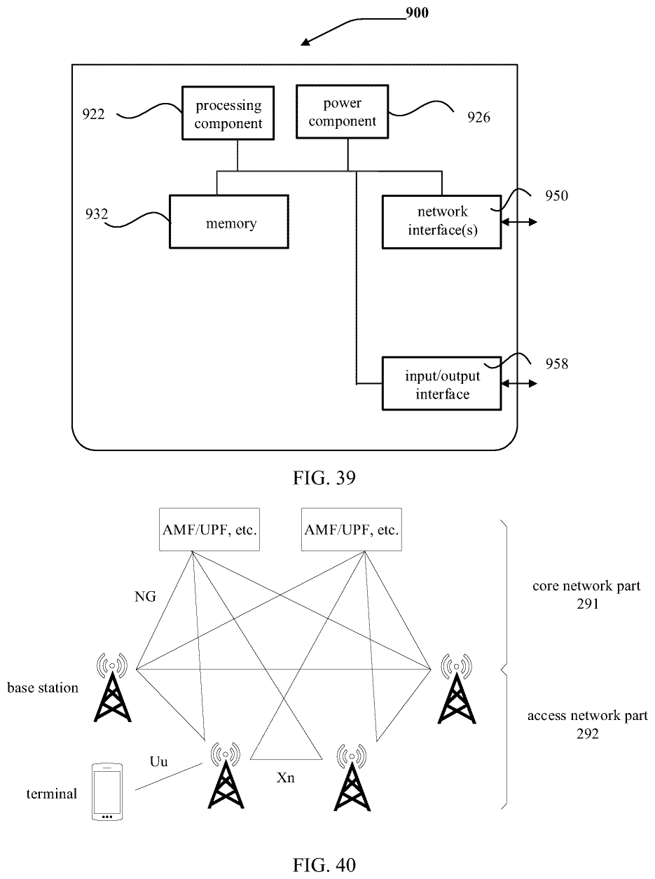

As shown in FIG. 39, an embodiment of the present disclosure shows a structure of a base station. For example, the base station 900 may be provided as a network side device. Referring to FIG. 39, the base station 900 includes a processing component 922 that further includes one or more processors, and memory resources represented by a memory 932 for storing instructions executable by the processing component 922, such as application programs. The application programs stored in the memory 932 may include one or more modules each corresponding to a set of instructions. Further, the processing component 922 is configured to execute the instructions to perform any of the above described methods which are applied at the base station.

The base station 900 may also include a power component 926 configured to perform power management of the base station 900, wired or wireless network interface(s) 950 configured to connect the base station 900 to a network, and an input/output (I/O) interface 958. The base station 900 may operate based on an operating system stored in the memory 932, such as Windows Server™, Mac OS X™, Unix™, Linux™, FreeBSD™, or the like.

As shown in in FIG. 40, an embodiment of the present disclosure shows network architecture of a 5G system, including a core network part 291 and an access network part 292. The core network part includes a core network device. The core network device mainly includes communication node(s) such as an Access and Mobility Management function (AMF), a User Plane Function (UPF), a Network Exposure Function (NEF), a User Data Repository (UDR) and a Session Management Function (SMF), etc. The access network part includes a base station. The AMF is mainly responsible for various functions including registration management, connection management, access management, mobility management, and security and access management and authorization. The UPF is mainly responsible for various functions related to data plane anchor point, PDU session point of connecting to a data network, packet routing and forwarding, traffic usage reporting and lawful intercept. The NEF is mainly responsible for related function for providing a secure way to expose the services and capabilities of 3GPP network functions to an AF and providing a secure way for the AF to provide information to 3GPP network functions. The UDR is mainly responsible for storing important procedure data in wireless communication procedure(s). The SMF is mainly responsible for various functions related to session management, charting and QoS policy control, lawful intercept, charging data collection and downlink data notification, etc.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

1. A method for monitoring an Artificial Intelligence (AI) or Machine Learning (ML) model, wherein the method is performed by a first communication node, and the method comprises:
performing performance monitoring of the Al or ML model for terminal positioning.

2. The method according to claim 1, further comprising:
obtaining assistance information, wherein the assistance information is used for performance monitoring of the Al or ML model for terminal positioning;
wherein performing performance monitoring of the Al or ML model for terminal positioning comprises:
based on the assistance information, performing performance monitoring of the Al or ML model for terminal positioning.

3. The method according to claim 2, wherein the first communication node is a Location Management Function (LMF), and the Al or ML model is run on the LMF.

4. The method according to claim 3, wherein obtaining the assistance information comprises at least one of:
receiving the assistance information sent by a base station, wherein the assistance information comprises: a measurement result determined based on an uplink positioning reference signal, or a measurement result of an uplink positioning reference signal of a terminal;
receiving the assistance information sent by the terminal, wherein the assistance information comprises: a measurement result determined by a downlink positioning reference signal;
receiving the assistance information sent by a Positioning Reference Unit (PRU), wherein the assistance information comprises: location information of the PRU and a measurement result determined based on a positioning reference signal; or
receiving assistance information sent by a Network Data Analytics Function (NWDAF), wherein the assistance information is used to indicate: information that a location of the terminal meets an expectation or information that the location of the terminal does not meet the expectation.

5. The method according to claim 4, further comprising at least one of:
sending, to the base station, request information for requesting the assistance information;
sending, to the terminal, request information for requesting the assistance information;
sending, to the PRU, request information for requesting the assistance information; or
sending, to the NWDAF, request information for requesting the assistance information.

6. The method according to claim 2, wherein the first communication node is a Location Management Function (LMF), and the model is run on a terminal.

7. The method according to claim 6, wherein obtaining the assistance information comprises at least one of:
receiving the assistance information sent by the terminal, wherein the assistance information comprises: a terminal location result predicted by the Al or ML model and a terminal location result determined by another positioning method other than the model; or a positioning signal measurement result predicted by the Al or ML model and a positioning reference signal measurement result obtained by the terminal by performing an actual positioning reference signal measurement;
receiving the assistance information sent by a PRU, wherein the assistance information comprises: location information of the PRU and a measurement result obtained by measuring a positioning reference signal; and
receiving the assistance information sent by a NWDAF, wherein the assistance information is used to indicate: information that a location of the terminal meets an expectation or information that the location of the terminal does not meet the expectation.

8. The method according to claim 7, further comprising at least one of:
sending, to the terminal, request information for requesting the assistance information;
sending, to the PRU, request information for requesting the assistance information; or
sending, to the NWDAF, request information for requesting the assistance information.

9. The method according to claim 6, further comprising:
sending model performance monitoring information to the terminal;
wherein the performance monitoring information indicates at least one of:
model performance not meeting a requirement;
the model performance meeting the requirement;
poor model performance;
a prediction result of the model being inconsistent with reality; or
poor positioning accuracy of the model; or
wherein the method further comprises:
sending operation information to the terminal;
wherein the operation information indicates at least one of:
information indicating the terminal to stop using the model;
information indicating the terminal to use another model; or
information indicating the terminal to update a parameter of the model.

10. (canceled)

11. The method according to claim 2, wherein the first communication node is a Location Management Function (LMF), and the model is run on a base station.

12. The method according to claim 11, wherein obtaining the assistance information comprises at least one of:
receiving the assistance information sent by the base station, wherein the assistance information comprises: a positioning reference signal measurement result predicted by the Al or ML model and a positioning reference signal measurement result obtained by the base station by performing an actual positioning reference signal measurement; or
receiving the assistance information sent by a PRU, wherein the assistance information is used to indicate: location information of the PRU and a measurement result obtained by measuring a positioning reference signal.

13. The method according to claim 12, further comprising at least one of:
sending, to the base station, request information for requesting the assistance information; or
sending, to the PRU, request information for requesting the assistance information.

14. The method according to claim 11, further comprising:
sending model performance monitoring information to the base station;
wherein the performance monitoring information indicates at least one of:
model performance not meeting a requirement;
the model performance meeting the requirement;
poor model performance;
a prediction result of the model being inconsistent with reality; or
poor positioning accuracy of the model; or
wherein the method further comprises:
sending operation information to the base station;
wherein the operation information indicates at least one of:
information indicating the base station to stop using the model;
information indicating the base station to use another model; or
information indicating the base station to update a parameter of the model.

15. (canceled)

16. The method according to claim 2, wherein the first communication node is a terminal, and the model is run on the terminal.

17. The method according to claim 16, further comprising:
sending, to an LMF, capability information of the terminal for model performance monitoring;
wherein the capability information indicates at least one of:
model information for a supported model;
monitoring of positioning accuracy being supported;
monitoring of a positioning measurement result being supported.

18.-24. (canceled)

25. The method according to claim 2, wherein the first communication node is a base station and the model is run on the base station.

26. The method according to claim 25, further comprising:
receiving request information for monitoring the model sent by an LMF.

27.-31. (canceled)

32. A method for monitoring an Artificial Intelligence (Al) or Machine Learning (ML) model, wherein the method is performed by a second communication node, and the method comprises:
sending assistance information to a first communication node;
wherein the assistance information is used for performance monitoring of the Al or ML model for terminal positioning.

33.-63. (canceled)

64. A communication device, comprising:
an antenna;
a memory; and
a processor connected to the antenna and the memory respectively, wherein the processor is configured to;
perform performance monitoring of an Al or ML model for terminal positioning.

65. (canceled)

66. A communication device, comprising:
an antenna;
a memory; and
a processor connected to the antenna and the memory respectively, wherein the processor is configured to perform the method according to claim 32.
